(19) United States
(12) Patent Application Publication
(10) Pub. No.: US 2004/0252213 A1
(43) Pub. Date: Dec. 16, 2004

(54) Image pick-up device

(75) Inventors: Hiroshi Itoh, Tokyo (JP); Seisuke Matsuda, Tokyo (JP); Shigeru Hosokai, Tokyo (JP); Yuichi Gomi, Tokyo (JP); Yoshio Hagihara, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/832,732

(22) Filed: Apr. 27, 2004

(30) Foreign Application Priority Data
Apr. 28, 2003 (JP) 2003-124307
May 28, 2003 (JP) 2003-151482

(51) Int. Cl. H04N 5/335

(52) U.S. Cl. 348/308

(57) ABSTRACT

A image pick-up device includes a pseudo signal generating circuit which generates a pseudo video signal, a pseudo signal reading circuit which reads and outputs the pseudo signal from the pseudo signal generating circuit, and a level control circuit which controls the level of a signal outputted by the pseudo signal generating circuit. The image pick-up device can detect the property difference in signal lines.

This application claims benefit of Japanese Application Nos. 2003-124307 filed in Japan on Apr. 28, 2003 and 2003-151482 filed in Japan on May 28, 2003, the contents of which are incorporated by this reference.

### BACKGROUND OF THE INVENTION

1. Field of the Invention

The present invention relates to an image pick-up device, and more particularly, to a multi-channel output type image pick-up device with the uniform structure.

2. Description of the Related Art

Conventionally, an XY-address solid image pick-up device is widely spread to read signals stored in pixels (pixel signals) by the driving control for the row direction and the column direction of the pixels arranged like matrix. In the above-mentioned image pick-up device, pixel signals from the pixels continuously ranged in the column direction are generally transmitted via the same vertical signal line. The pixel signals from the vertical signal line of the columns in the selected row are outputted in order of the columns by a horizontal reading circuit, and the pixel signals on one screen are read by sequentially shifting the selected row.

Then, an amplifier for amplifying the pixel signals is often arranged to the vertical signal line. However, in the case of providing the amplifier for each vertical signal line, the properties of the amplifiers are not uniform and therefore the variation in amplifier properties causes strip noises, thus deteriorating the image signal.

Japanese Unexamined Patent Application Publication No. 2000-295533 (Patent Document 1) discloses an image pick-up device to solve the above-mentioned problem. FIG. 1 is an explanatory diagram of a technology disclosed in Patent Document 1.

Referring to FIG. 1, an example is given of an XY-address solid image pick-up device having a pixel area comprising four pixels of (2×2). A vertical scanning circuit Y1 selects the row of the pixel signal to be read from pixels P₁₁ to Pₐₐ, a horizontal reading circuit X₁ selects the column to be read, and outputs the signals. The pixel signals in the row selected by a vertical scanning circuit Y₁ are supplied to line amplifiers A₁ and A₂ via signal reading lines of the respective columns (hereinafter, referred to vertical signal lines). A DC bias generating circuit V₁ sets DC bias levels of the respective line amplifiers A₁ and A₂. The line amplifiers A₁ and A₂ amplify and output the pixel signals in the columns at the operation point corresponding to the set DC bias levels.

The DC bias generating circuit V₁ can control the operation points of the line amplifiers A₁ and A₂, thus to prevent the deterioration in pixel signals due to the variation in characteristic of the line amplifiers A₁ and A₂.

### SUMMARY OF THE INVENTION

According to the present invention, an image pick-up device includes pseudo signal generating means which generates a pseudo video signal, pseudo signal reading means which reads and outputs the pseudo signal from the pseudo signal generating means, and level control means which controls the level of a signal outputted by the pseudo signal generating means.

The above and other objects, features and advantages of the invention will become more clearly understood from the following description referring to the accompanying drawings.

### BRIEF DESCRIPTION OF THE DRAWINGS

FIG. 1 is an explanatory diagram of a technology disclosed in Patent Document 1;

FIG. 2 is an explanatory diagram showing an image pick-up device according to the first embodiment of the present invention;

FIG. 3 is a timing chart for explaining one example of the reading operation according to the first embodiment;

FIG. 4 is a timing chart for explaining another example of the reading operation according to the first embodiment;

FIG. 5 is a timing chart for explaining another example of the reading operation according to the first embodiment;

FIG. 6 is an explanatory diagram showing an image pick-up device according to the second embodiment of the present invention;

FIG. 7 is an explanatory diagram showing an image pick-up device according to the third embodiment of the present invention;

FIG. 8 is a timing chart for explaining one example of the reading operation of signals from output systems according to the third embodiment;

FIG. 9 is a timing chart for explaining another example of the reading operation of signals from output systems according to the third embodiment;

FIG. 10 is an explanatory diagram showing an image pick-up device according to a modification of the third embodiment;

FIG. 11 is a timing chart for explaining the operation of the image pick-up device according to the modification of the third embodiment;

FIG. 12 is an explanatory diagram showing an image pick-up device according to the fourth embodiment of the present invention;

FIG. 13 is a timing chart for explaining one example of the reading operation of signals from output systems according to the fourth embodiment;

FIG. 14 is a timing chart for explaining another example of the reading operation of signals from the output systems according to the fourth embodiment;

FIG. 15 is a timing chart for explaining another example of the reading operation of signals from the output systems according to the fourth embodiment;

FIGS. 16A and 16B are explanatory diagrams showing an image pick-up device according to the fifth embodiment of the present invention;

FIGS. 17A and 17B are explanatory diagrams showing an image pick-up device according to the sixth embodiment of the present invention;

FIGS. 18A and 18B are explanatory diagrams showing an image pick-up device according to the seventh embodiment of the present invention;

FIG. 19 is an explanatory diagram showing an image pick-up device according to the eighth embodiment of the present invention;

FIG. 20 is an explanatory diagram showing an image pick-up device according to the ninth embodiment of the present invention;

FIG. 21 is an explanatory diagram showing an image pick-up device according to the tenth embodiment of the present invention;

FIG. 22 is an explanatory diagram showing an image pick-up device according to a modification of the tenth embodiment;

FIG. 23 is an explanatory diagram showing an image pick-up device according to the eleventh embodiment of the present invention;

FIG. 24 is an explanatory diagram showing an image pick-up device according to the twelfth embodiment of the present invention;

FIG. 25 is an explanatory diagram showing an image pick-up device according to the thirteenth embodiment of the present invention;

FIG. 26 is a circuit diagram showing one example of a pseudo signal reading circuit or a horizontal reading circuit in FIGS. 19 to 23 in the case of canceling FPN; and

FIG. 27 is a circuit diagram showing another example of the pseudo signal reading circuit or the horizontal reading circuit in FIGS. 19 to 23 in the case of clamping and canceling the FPN.

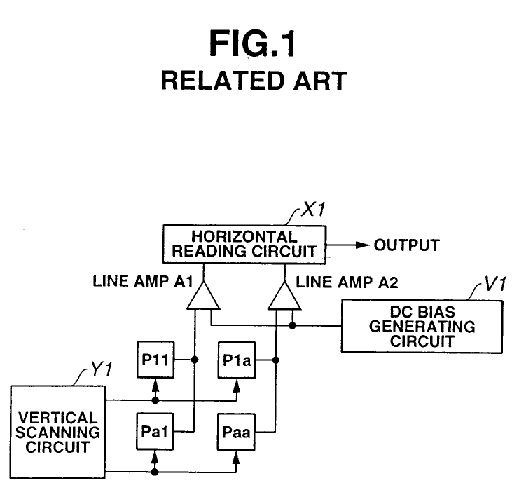

### DESCRIPTION OF THE PREFERRED EMBODIMENTS

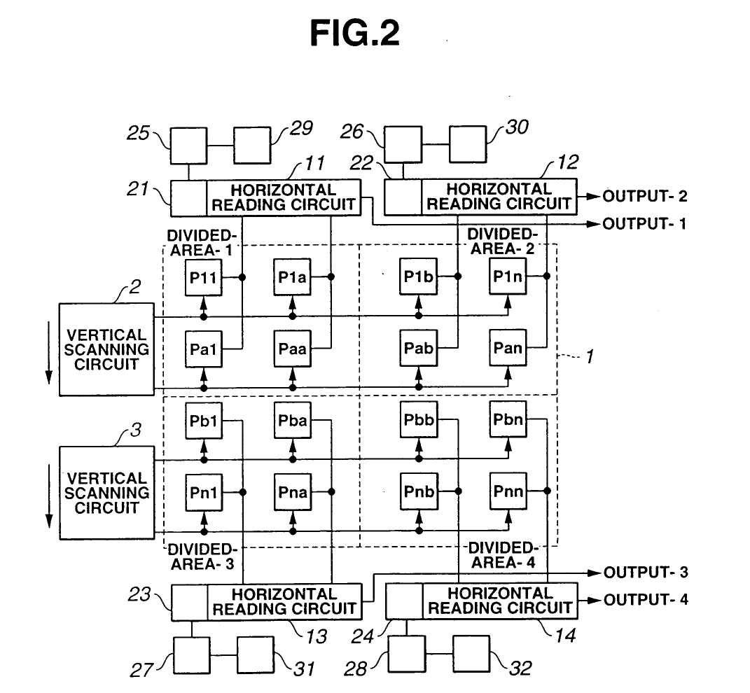

Hereinbelow, the embodiments of the present invention will be described with reference to the drawings. FIG. 2 is an explanatory diagram showing an image pick-up device according to the first embodiment of the present invention.

The image pick-up device shown in FIG. 2 has vertical scanning circuit 2 and vertical scanning circuit 3 and four-system horizontal reading circuits 11 to 14. The four horizontal reading circuits 11 to 14 simultaneously obtain four-channel output-1 to output-4. The output-1 to output-4 are combined, thereby obtaining video signals of one screen.

A pixel area 1 comprises pixels P₁₁ to Pₙₘ arranged like matrix. For the purpose of a brief description, referring to FIG. 2, the pixel area 1 comprising (4×4) pixels are shown, assuming a=2, b=3, and n=4. A pixel Pᵤᵥ (1≦u, v≦n) has a photoelectrically converting element and a switch (which are not shown). The photoelectrically converting element forming the pixel Pᵤᵥ stores signals corresponding to incident light. The signals stored in the photoelectrically converting element are outputted via the switch in the pixel. The pixel area 1 is divided into four divided-area-1 to divided-area-4 containing two areas in the vertical direction and two areas in the horizontal direction. The number of division can properly be set.

The pixels on the same row are connected to a common horizontal selecting line. The horizontal selecting line supplies a row selecting signal to the switch in the pixel. The switch in the pixel is on/off controlled by the row selecting signal transmitted by the horizontal selecting line.

The vertical scanning circuit 2 supplies the row selecting signal to the horizontal selecting line connected to the pixels in the divided-area-1 and divided-area-2. The vertical scanning circuit 3 supplies the row selecting signal to the horizontal selecting line connected to the pixels in the divided-area-3 and divided-area-4. The vertical scanning circuit 2 and vertical scanning circuit 3 have the identical structure and have a pulse transfer unit and an output terminal corresponding to the respective rows in the pixel area. The output terminal of the vertical scanning circuit 2 is respectively connected to the horizontal selecting line of the rows in the divided-area-1 and divided-area-2. The output terminal of the vertical scanning circuit 3 is respectively connected to the horizontal selecting line of the rows in the divided-area-3 and divided-area-4. The vertical scanning circuit 2 and vertical scanning circuit 3 selectively and respectively supply the row selecting signals to the horizontal selecting line of the row.

In the vertical scanning circuit 2 and vertical scanning circuit 3, for example, the pulse transfer unit receives a vertical start pulse (not shown) synchronous with a vertical synch signal, pulses are sequentially transferred to the pulse transfer unit of the next row at a predetermined clock timing (not shown), and the row selecting signals are outputted from the output terminals to the respective rows.

On the other hand, the pixels on the same column in the divided-area-1 and divided-area-2 are connected to the common vertical signal line, and the pixels on the same column in the divided-area-3 and divided-area-4 are connected to the common vertical signal line. That is, the photoelectrically converting element in the pixel of the column is connected to the vertical signal line of the corresponding column via the respective switch in the pixel. By turning on the switch in the pixel, the signal stored in the pixel is transmitted to the connected vertical signal line.

The horizontal reading circuits 11 to 14 have mutually the same structure, and each has a pulse transfer unit (including a signal output unit) corresponding to each column in the pixel area and has an input terminal. The respective input terminals of the horizontal reading circuits 11 and 12 are connected to the vertical signal lines in the divided-area-1 and divided-area-2, and the respective input terminals of the horizontal reading circuits 13 and 14 are connected to the respective vertical signal lines of the columns in the divided-area-3 and divided-area-4.

For example, in the respective horizontal reading circuits 11 to 14, the pulse transfer unit in the predetermined column receives horizontal start pulses (not shown) and pulses are sequentially transferred to the next pulse transfer unit at a predetermined clock timing (not shown). The each pulse transfer unit (signal output unit) fetches the pixel signal via the vertical signal line connected to the input terminal corresponding to the each column during a clock period based on the transferred pulses, and outputs the output-1 to output-4 from the respective output terminals of the horizontal reading circuits 11 to 14.

With the above-mentioned structure, in the divided-area-1, the vertical scanning circuit 2 and the horizontal reading circuit 11 read the pixel signal. In the divided-area-2, the vertical scanning circuit 2 and the horizontal reading circuit 12 read the pixel signal. In the divided-area-3, the vertical scanning circuit 3 and the horizontal reading circuit 13 read the pixel signal. In the divided-area-4, the vertical scanning circuit 3 and the horizontal reading circuit 14 read the pixel signal.

According to the first embodiment, pseudo signal reading circuits 21 to 24, pseudo signal generating circuits 25 to 28, and level control circuits 29 to 32 are provided corresponding to the divided-area-1 to divided-area-4. The pseudo signal generating circuits 25 to 28 generate pseudo signals at a desired level and outputs the generated signals to the pseudo signal reading circuits 21 to 24. The level control circuits 29 to 32 control the pseudo signal generating circuits 25 to 28 and sets the level of the generated pseudo signal to a desired level. The pseudo signal reading circuits 21 to 24 read the pseudo signals respectively generated by the pseudo signal generating circuits 25 to 28, and output the output-1 to output-4 from the horizontal reading circuits 11 to 14.

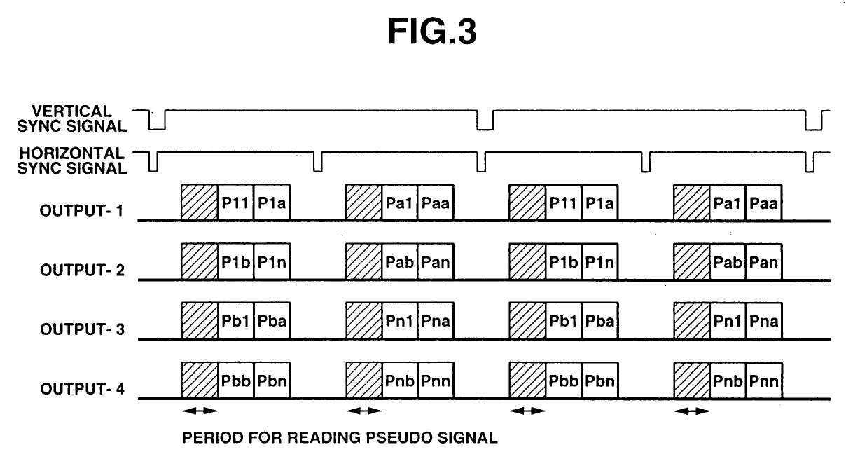

Next, the operation with the above-mentioned structure will be described with reference to FIGS. 3 to 5 according to the first embodiment. FIGS. 3 to 5 are timing charts for explaining the reading operation.

The vertical scanning circuit 2 and vertical scanning circuit 3 and the horizontal reading circuits 11 to 14 operate synchronously with the vertical synch signal and horizontal sync signal shown in FIG. 3. That is, the respective rows are selected at the cycle for generating the horizontal sync signal, and the pixel signal of the pixels in the each row selected in every divided area is read. At the cycle of the vertical synch signal, the entire rows are selected in every divided area and the pixel signals of the pixels on the one screen are obtained.

According to the first embodiment, after generating the respective horizontal synch signals and before reading the pixel signal from the vertical signal line in the pixel area, the pseudo signal reading circuits 21 to 24 corresponding to the divided-area-1 to divided-area-4 read the pseudo signals.

First, the vertical scanning circuit 2 and vertical scanning circuit 3 receive vertical start pulses (not shown) and starts the output of the row selecting signal. The vertical scanning circuit 2 outputs the row selecting signal to the horizontal selecting line at the first row by the pulse transfer unit at the first row, and the vertical scanning circuit 3 outputs the row selecting signal to the horizontal selecting line at the third row by the pulse transfer unit at the third row (first rows in the divided-area-3 and divided-area-4). Thus, the pixel signals of the pixels at the first row in the divided-area-1 to divided-area-4 are outputted to the corresponding vertical signal line.

In this state, the pseudo signal generating circuit 25 generates the desired-level pseudo signal under the control of the level control circuit 29. The pseudo signal reading circuit 21 reads the pseudo signal generated by the pseudo signal generating circuit 25 and outputs the read signal as the output-1 from the horizontal reading circuit 11 (hatched portion of the output-1 in FIG. 3). Similarly, the pseudo signal generating circuits 26 to 28 generate the desired-level pseudo signals under the control of the respective level control circuits 30 to 32. The pseudo signal reading circuits 22 to 24 read the pseudo signals respectively generated by the pseudo signal generating circuits 26 to 28, and outputs the read signals as the output-2 to output-4 of the horizontal reading circuits 12 to 14 (hatched portions of the output-2 to output-4 in FIG. 3).

After that, horizontal start pulses (not shown) are supplied to the horizontal reading circuits 11 to 14 and then the horizontal reading circuits 11 to 14 read pixel signals P₁₁, P_{1b}, P_{b1}, and P_{bb} of pixels P₁₁, P_{1b}, P_{b1}, and P_{bb} at the first columns in the divided areas, and output the read signals as the output-1 to output-4. Next, at a predetermined clock timing, horizontal start pulses are transferred to the pulse transfer unit at the next column, the horizontal reading circuits 11 to 14 read pixel signals P₁ₐ, P₁ₙ, P_{ba}, and P_{bn} of pixels P₁ₐ, P₁ₙ, P_{ba}, and P_{bn} at the second columns in the divided areas, and output the read signals as the output-1 to output-4.

At the next horizontal reading period (horizontal scanning period), the vertical scanning circuit 2 and vertical scanning circuit 3 shift the row selecting signal, and the pseudo signals are first read similarly to the previous horizontal scanning period. Then, the horizontal start pulses are supplied to the horizontal reading circuits 11 to 14 and, then, the horizontal reading circuits 11 to 14 read pixel signals Pₐ₁, P_{ab}, Pₙ₁, and P_{nb} of pixels Pₐ₁, P_{ab}, Pₙ₁, and P_{nb} at the first columns in the respective divided areas, and output the read signals as the output-1 to output-4. Next, at a predetermined clock timing, the horizontal start pulses are transferred to the pulse transfer unit at the next column, the horizontal reading circuits 11 to 14 read pixel signals Pₐₐ, Pₐₙ, Pₙₐ, and Pₙₙ of pixels Pₐₐ, Pₐₙ, Pₙₐ, and Pₙₙ at the second columns in the respective divided areas, and output the read signals as the output-1 to output-4.

At the next vertical reading period, the similar reading operation is performed. As mentioned above, at the first period for reading the pseudo signal of the horizontal reading period, the pseudo signals are simultaneously outputted as the output-1 to output-4 of the four horizontal reading circuits 11 to 14.

As mentioned above, according to the first embodiment, the pseudo signals are outputted before reading the pixel signal every horizontal reading period. The pseudo signal functions as a test signal. Therefore, the signals outputted as the output-1 to output-4 are monitored, thereby correcting the property variation of the output systems such as the horizontal reading circuits in the post-state processing circuit.

The pseudo signal reading circuits 21 to 24 comprise respectively the first-stage pulse transfer units in the horizontal reading circuits 11 to 14. The pseudo signal from the pseudo signal generating circuit 21 can be supplied to the first-stage pulse transfer unit, and the outputs from the vertical signal lines at the columns in the divided areas can be supplied to the pulse transfer units of second and sequent states. At the period for reading the pseudo signal after starting the horizontal scanning, the horizontal start pulses are supplied to the first-stage pulse transfer unit, thereby reading the signal similarly to the case shown in FIG. 3.

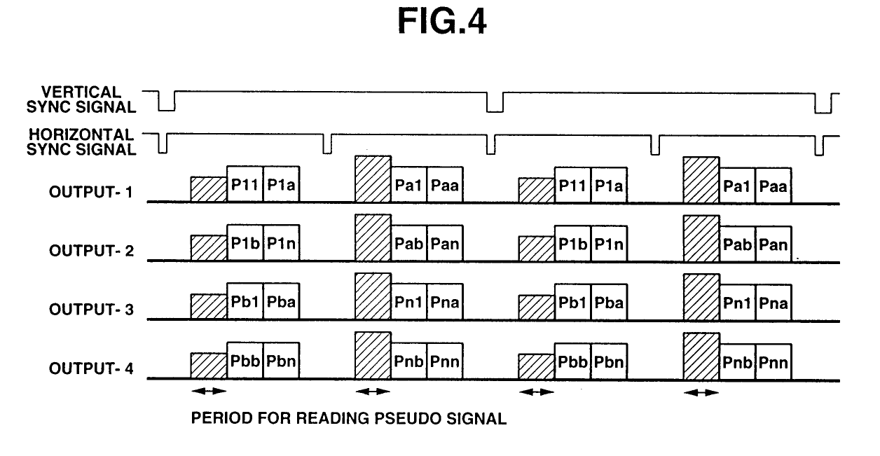

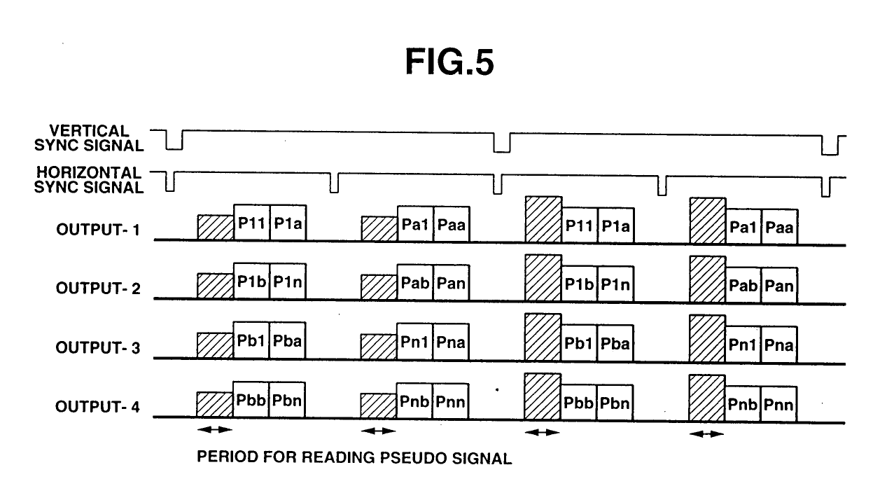

According to the first embodiment, the level control circuits 29 to 32 can change the levels of the pseudo signals outputted as the output-1 to output-4. FIGS. 4 and 5 show examples in this case.

FIG. 4 shows the example in which the levels of the pseudo signals outputted as the output-1 to output-4 are changed every horizontal reading period during the vertical scanning period.

FIG. 5 shows the example in which the levels of the pseudo signals outputted as the output-1 to output-4 in every horizontal reading period during the vertical scanning period are the same and the levels of the pseudo signals are changed in every vertical scanning period. As mentioned above, the pseudo signals at the desired levels are obtained from the respective output systems.

According to the first embodiment, the variation in offsets in the output systems is corrected by using the pseudo signals outputted. Since the levels of the pseudo signals properly can be changed, the variation in linearity of the output systems can also be corrected.

According to the first embodiment, the pseudo signal is outputted at the first timing of the every horizontal reading period. However, the present invention is not limited to this. The pseudo signal may be outputted after reading the pixel signal in every horizontal reading period or in every vertical scanning period. Further, the pseudo signal may not be outputted at an arbitrary period but may only at the necessary timing.

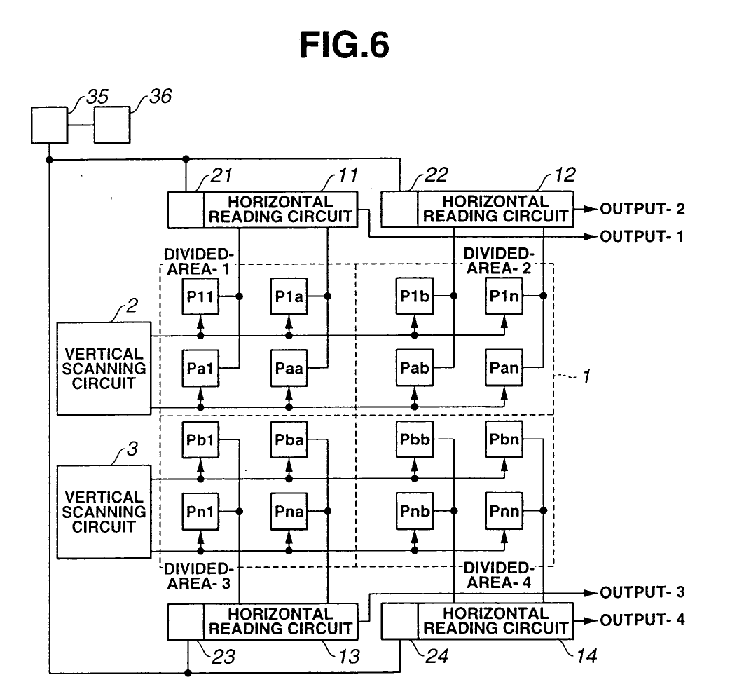

FIG. 6 is an explanatory diagram showing an image pick-up device according to the second embodiment of the present invention. Referring to FIG. 6, the same components as those in FIG. 2 are designated by the same reference numerals and a description thereof is omitted.

According to the first embodiment, the pseudo signal reading circuit, the pseudo signal generating circuit, and the level control circuit are provided in every divided area. However, the pseudo signal generating circuit and the level control circuit can be shared in the entire divided areas. The second embodiment shows an example of this modification.

Unlike the first embodiment, according to the second embodiment, the pseudo signal generating circuits 25 to 28 and the level control circuit 29 to 32 are omitted and a pseudo signal generating circuit 35 and a level control circuit 36 are added. The pseudo signal generating circuit 35 generates the pseudo signal at the desired level under the control of the level control circuit 36. The pseudo signal from the pseudo signal generating circuit 35 is supplied to the pseudo signal reading circuits 21 to 24 corresponding to the divided areas.

With the above-mentioned structure according to the second embodiment, the pseudo signal reading circuits 21 to 24 receive the pseudo signals at the desired levels generated by the pseudo signal generating circuit 35. At a predetermined timing, the pseudo signal reading circuits 21 to 24 read the pseudo signal from the pseudo signal generating circuit 35 and outputs the read signals as the output-1 to output-4.

The level control circuit 36 controls the level of the pseudo signal generated by the pseudo signal generating circuit 35.

Thus, according to the second embodiment, similarly to the case shown in FIGS. 3 to 5, the signals additionally having the pseudo signals are outputted from the output systems, and the advantages as those according to the first embodiment are obtained. Further, according to the second embodiment, the pseudo signal generating circuit and the level control circuit are shared, thereby preventing the harmful influence due to the variation in the pseudo signal generating circuit and the level control circuit.

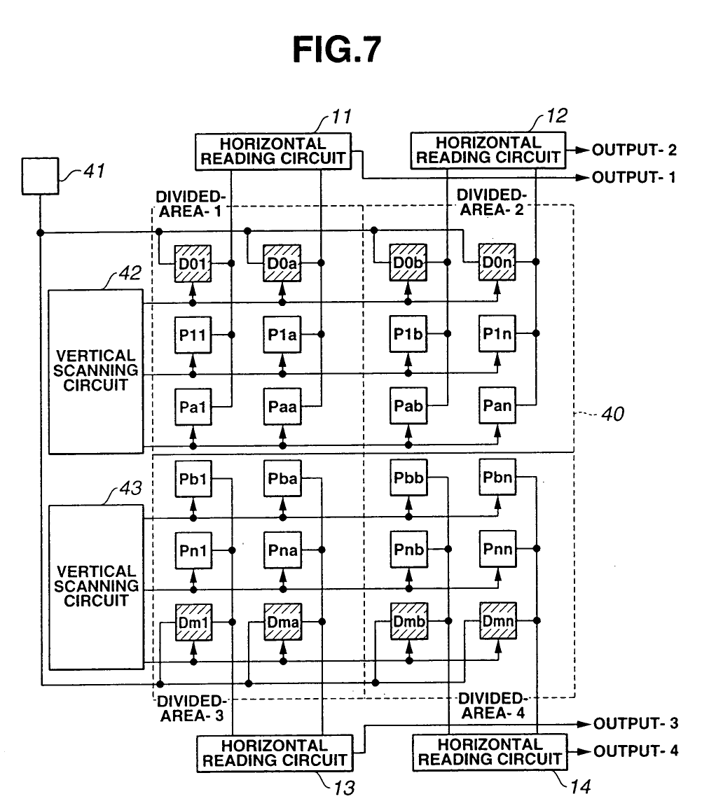

FIG. 7 is an explanatory diagram showing an image pick-up device according to the third embodiment of the present invention. Referring to FIG. 7, the same components as those shown in FIG. 2 are designated by the same reference numerals and a description thereof is omitted.

According to the first embodiment, the pseudo signal generating circuit is arranged to the outside of the pixel area. However, according to the third embodiment, the pseudo signal generating circuit is arranged in the pixel area.

Similarly to the pixel area 1 shown in FIG. 2, a pixel area 40 has the pixels P₁₁ to Pₙₙ arranged like matrix. Further, according to the third embodiment, the pixel area 40 has pseudo signal generating circuits D₀₁ to D₀ₙ at the row on the top end in the vertical direction (hereinafter, referred to as a 0-th row) and pseudo signal generating circuits Dₘ₁ to Dₘₙ at the row on the bottom end in the vertical direction (hereinafter, referred to as an m-th row). Referring to FIG. 7, for the purpose of a brief description, it is assumed that a=2, b=3, n=4, and m=5. The structure of the pixel Pᵤᵥ (1≦u, v≦n) is the same as that shown in FIG. 2. The pseudo signal generating circuits D₀₁ to D₀ₐ are included in the divided-area-1, the pseudo signal generating circuits D_{0b} to D₀ₙ are included in the divided-area-2, the pseudo signal generating circuits Dₘ₁ to Dₘₐ are included in the divided-area-3, and the pseudo signal generating circuits D_{mb} to Dₘₙ are included in the divided-area-4.

According to the third embodiment, the pseudo signal generating circuits D₀₁ to D₀ₙ and Dₘ₁ to Dₘₙ generate the pseudo signals at the desired levels under the control of a level control circuit 41. The pseudo signal generating circuits D₀₁ to D₀ₙ and Dₘ₁ to Dₘₙ output the generated pseudo signals via switches formed within the pseudo signal generating circuits. According to the third embodiment, the respective switches of the pseudo signal generating circuits D₀₁ to D₀ₙ receive the row selecting signals from a common horizontal selecting line formed in the pixel area 40, and are controlled for the on/off operation based on the row selecting signal. The respective switches of the pseudo signal generating circuits Dₘ₁ to Dₘₙ receive the row selecting signals from the common horizontal selecting line formed in the pixel area 40, and are controlled for the on/off operation based on the row selecting signal. The horizontal selecting line for supplying the row selecting signal to the respective switches of the pseudo signal generating circuits D₀₁ to D₀ₙ is connected to the output terminal of the pulse transfer unit at the 0-th row as the first row of a vertical scanning circuit 42. The horizontal selecting line for supplying the row selecting signal to the respective switches of the pseudo signal generating circuits Dₘ₁ to Dₘₙ is connected to the output terminal of the pulse transfer unit at the m-th row of the vertical scanning circuit 43.

The vertical scanning circuit 42 and vertical scanning circuit 43 have the same structure as those of the vertical scanning circuit 2 and vertical scanning circuit 3 shown in FIG. 2, and have output terminals and the pulse transfer units corresponding to the 0-th to m-th rows within the pixel area 40. Similarly to the first embodiment, the vertical scanning circuit 42 and vertical scanning circuit 43 operate independently. The vertical scanning circuit 42 sequentially outputs the row selecting signal to the horizontal selecting lines at the 0-th to a-th lines in the divided-area-1 and divided-area-2. The vertical scanning circuit 43 sequentially outputs the row selecting signal to the horizontal selecting lines at the b-th to m-th lines in the divided-area-3 and divided-area-4.

The switch in the pseudo signal generating circuit D₀₁ is connected to the vertical signal line at the first column in the divided-area-1. The switch is turned on, thereby outputting, to the vertical signal line at the first column, the pseudo signal generated by the pseudo signal generating circuit D₀₁. Similarly, the switch in the pseudo signal generating circuit D₀ᵥ is connected to the vertical signal line at the v-th column in the divided-area-1 and divided-area-2. The switch is turned on, thereby outputting, to the vertical signal line at the v-th column, the pseudo signal generated by the pseudo signal generating circuit D₀ᵥ. The switch in the pseudo signal generating circuit Dₘᵥ is connected to the vertical signal line at the v-th column in the divided-area-3 and divided-area-4. The switch is turned on, thereby outputting, to the vertical signal line at the v-th column in the divided-area-3 and divided-area-4, the pseudo signal generated by the pseudo signal generating circuit Dₘᵥ.

The level control circuit 41 supplies control signals to the pseudo signal generating circuits D₀₁ to D₀ₙ and Dₘ₁ to Dₘₙ by a level control line so as to control the pseudo signal generating circuits D₀₁ to D₀ₙ and Dₘ₁ to Dₘₙ and to generate the pseudo signals at the desired levels.

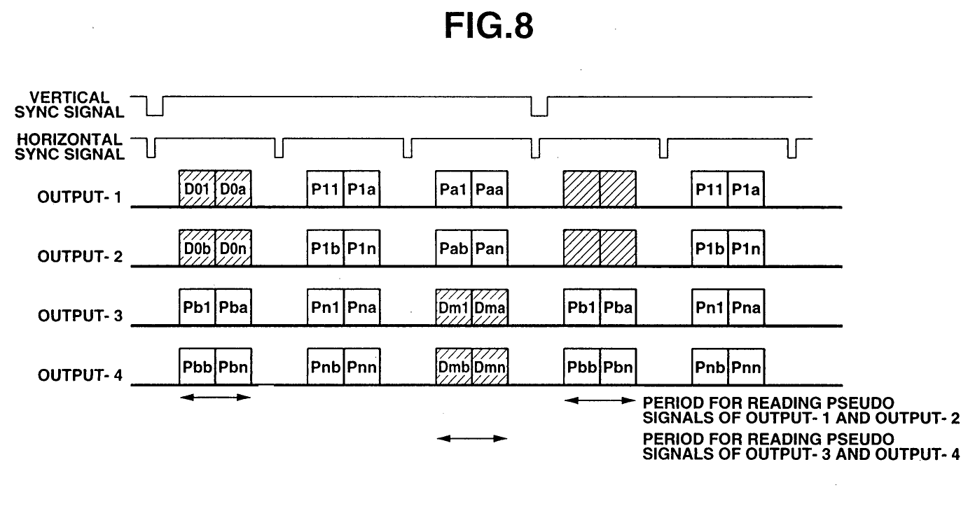

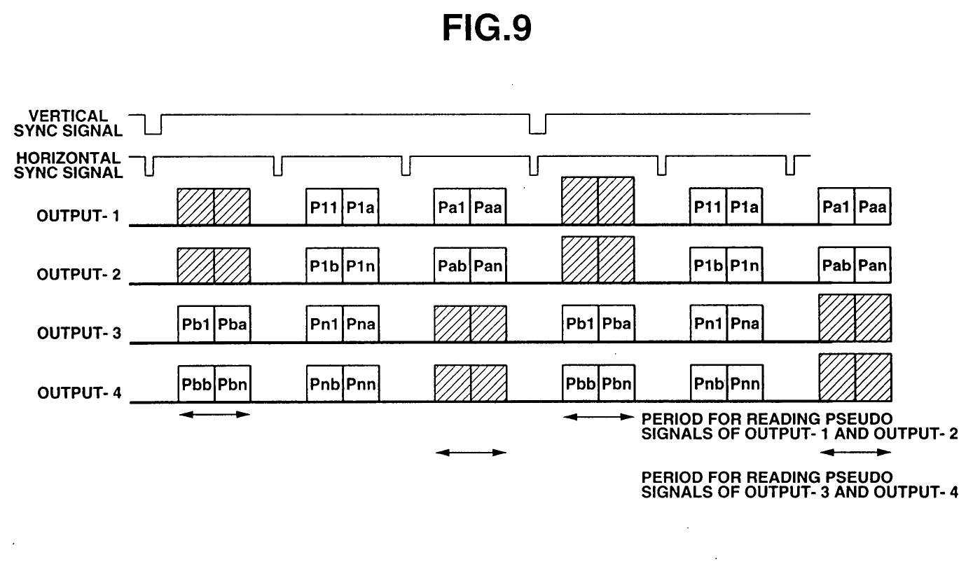

Next, the operation with the above-mentioned structure will be described with reference to FIGS. 8 and 9 according to the third embodiment. FIGS. 8 and.9 are timing charts for explaining the reading operation of the signals from the output systems.

According to the third embodiment, the vertical scanning circuit 42 and vertical scanning circuit 43 and the horizontal reading circuits 11 to 14 operate synchronously with the vertical sync signal and horizontal sync signal shown in FIG. 8. That is, the respective rows are selected at the cycle for generating the horizontal sync signal, and the pixel signals of the pixels at the respective rows selected in every divided area are read. At the cycle of the vertical sync signal, the entire rows are selected in every divided area and the pixel signals of the pixel on the one screen are obtained. In this case, the vertical scanning circuit 42 and vertical scanning circuit 43 select the 0-th and m-th rows at which the pseudo signal generating circuits D₀₁ to D₀ₙ and Dₘ₁ to Dₘₙ are arranged, similarly to the usual reading operation of the pixels.

The pseudo signal generating circuits D₀₁ to D₀ₙ and Dₘ₁ to Dₘₙ generate the pseudo signals at the desired levels under the control of the level control circuit 41. Vertical start pulses (not shown) are supplied to the vertical scanning circuit 42 and vertical scanning circuit 43, then, the vertical scanning starts, and the vertical scanning circuit 42 and vertical scanning circuit 43 first output the row selecting signals to the horizontal selecting line at the 0-th (first rows at the divided-area-1 and divided-area-2) and at the b-th (first lines at the divided-area-3 and divided-area-4).

Thus, at the divided-area-1 and divided-area-2, the pseudo signals generated by the pseudo signal generating circuits D₀₁ to D₀ₙ are outputted to the vertical signal line of the columns. At the divided-area-3 and divided-area-4, the pixel signals of the pixels at the first rows are outputted to the corresponding vertical signal line.

In this state, when horizontal start pulses (not shown) are supplied to the horizontal reading circuits 11 to 14, the horizontal reading circuits 11 to 14 extract the signals outputted to the vertical signal line at the first column at the divided area, and output the extracted signals as the output-1 to output-4. That is, in this case, referring to FIG. 8, the pseudo signals D₀₁ and D₀ₐ from the pseudo signal generating circuits D₀₁ and D₀ₐ are outputted as the output-1. The pseudo signals D_{0b} to D₀ₙ from the pseudo signal generating circuits D_{0b} to D₀ₙ are outputted as the output-2. The pixel signals P_{b1} and P_{ba} from the pixels P_{b1} and P_{ba} are outputted as the output-3, and the pixel signals P_{bb} and P_{bn} from the pixels P_{bb} and P_{bn} are outputted as the output-4.

At the next horizontal reading period, the similar reading operation is performed, the pixel signals P₁₁, P_{1b}, Pₙ₁, and P_{nb} are first outputted as the output-1 to output-4 from the horizontal reading circuits 11 to 14. Subsequently, the pixel signals P₁ₐ, P₁ₙ, Pₙₐ, and Pₙₙ are outputted.

Further, at the next horizontal reading period, the similar reading operation is performed. First, the pixel signals Pₐ₁ and P_{ab} are outputted as the output-1 and output-2 from the horizontal reading circuits 11 and 12, and the pseudo signals Dₘ₁ and D_{mb} from the pseudo signal generating circuits Dₘ₁ and D_{mb} are outputted as the output-3 and output-4 from the horizontal reading circuits 13 and 14. Next, the pixel signals Pₐₐ and Pₐₙ are outputted as the output-1 and output-2 from the horizontal reading circuits 11 and 12. The pseudo signals Dₘₐ and Dₘₙ from the pseudo signal generating circuits Dₘₐ and Dₘₙ are outputted as the output-3 and output-4 from the horizontal reading circuits 13 and 14. As mentioned above, the reading operation shown in FIG. 8 is performed.

According to the third embodiment, the signals including the pseudo signals can be read as the output-1 to output-4 from the respective output systems. The level control circuit 41 can change the level of the pseudo signal, and the pseudo signal can be used as a test signal for correcting the properties of the output systems.

In the example shown in FIG. 8, in the case of the output-1 and output-2, the first horizontal reading period becomes the pseudo signal reading period. In the case of the output-3 and output-4, the last horizontal reading period becomes the pseudo signal reading period. By inverting one scanning direction of the vertical scanning circuit 42 and vertical scanning circuit 43, the positions of the pseudo signal reading periods can match among the output-1 to output-4.

FIG. 9 shows the example in which the pseudo signal levels outputted as the output-1 to output-4 are mutually the same for the respective horizontal reading periods in a vertical scanning period and in which the level of the pseudo signal is changed every vertical scanning period. As mentioned above, the pseudo signal at the desired level can be obtained from the output systems.

According to the third embodiment, the variation in offsets of the output systems can be corrected by using the pseudo signals outputted. Since the level of the pseudo signal can properly be changed, the variation in linearity of the output systems can be corrected.

According to the third embodiment, by arranging the pseudo signal generating circuit in the pixel area, there is a merit that the symmetry is improved on the device layout and the area is reduced.

According to the third embodiment, the pseudo signal generating circuit is arranged around the pixel area. However, it can be arranged on the inner of the pixel area. The influence on the image of the pseudo signal generating circuit arranged in the pixel area can be suppressed by the post-stage signal processing.

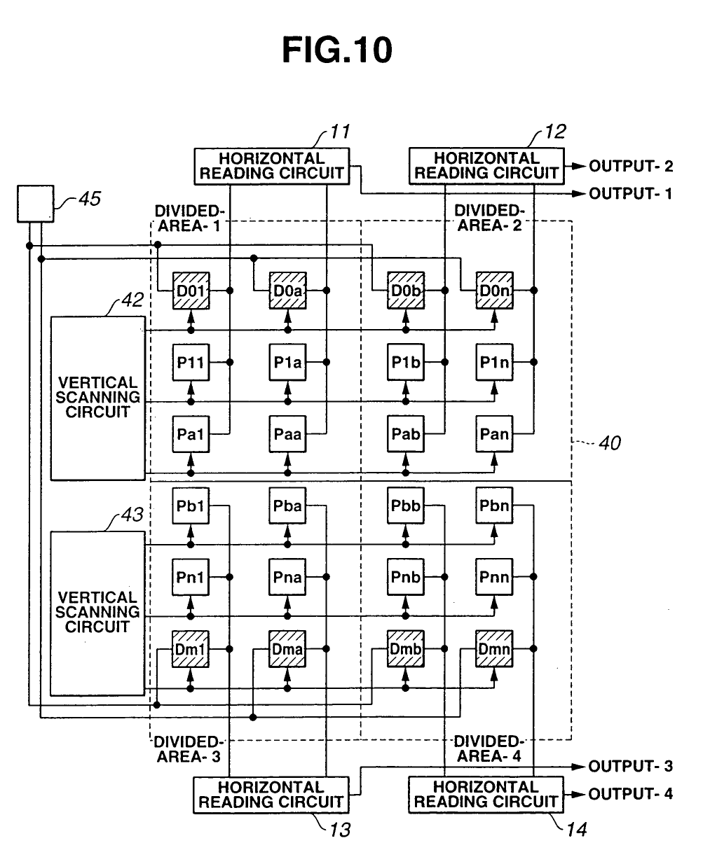

FIG. 10 is an explanatory diagram of an image pick-up device according to one modification of the third embodiment.

In the example shown in FIG. 10, by using a level control circuit 45 which can control a plurality of levels in place of the level control circuit 41 shown in FIG. 7, the levels of the pseudo signals from the pseudo signal generating circuit at the same row can individually be controlled. One level control line from the level control circuit 45 supplies a signal for level control to the pseudo signal generating circuits D₀₁, D_{0b}, Dₘ₁, and D_{mb}. Another level control line from the level control circuit 45 supplies a signal for level control to the pseudo signal generating circuits D₀ₐ, D₀ₙ, Dₘₐ, and Dₘₙ.

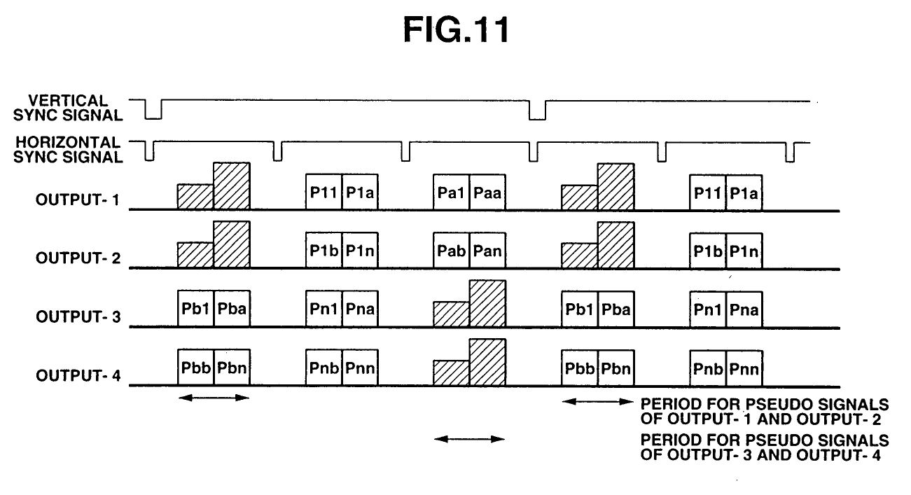

In this case, referring to FIG. 11, it is possible to change the levels of the pseudo signals D₀₁, D_{0b}, Dₘ₁, and D_{mb} from the pseudo signal generating circuits D₀₁, D_{0b}, Dₘ₁, and D_{mb} and the levels of the pseudo signals D₀ₐ, D₀ₙ, Dₘₐ, and Dₘₙ from the pseudo signal generating circuits D₀ₐ, D₀ₙ, Dₘₐ, and Dₘₙ.

As mentioned above, in this example, the pseudo signal level can be changed every pixel cycle. Obviously, the level control can be changed not only for every pseudo signal generating circuit but also for every plural units of circuit.

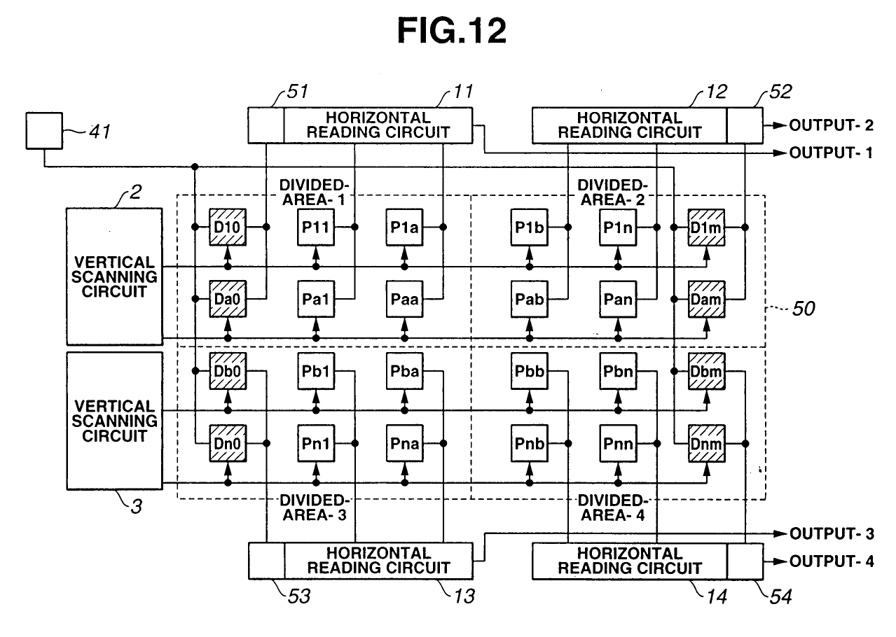

FIG. 12 is an explanatory diagram showing an image pick-up device according to the fourth embodiment of the present invention. Referring to FIG. 12, the same components as those shown in FIG. 2 or 7 are designated by the same reference numerals, and a description thereof is omitted.

According to the forth embodiment, the pseudo signal generating circuit is arranged to the columns in the pixel area at both ends thereof in the horizontal direction.

Similarly to the pixel area 1 shown in FIG. 2, pixels P₁₁ to Pₙₙ are arranged like matrix in a pixel area 50. Further, in the pixel area 50 according to the fourth embodiment, the pseudo signal generating circuits D₁₀ to Dₙ₀ are formed to the column at the left end in the horizontal direction (hereinafter, referred to as the 0-th column), and the pseudo signal generating circuits D₁ₘ to Dₙₘ are formed to the column at the right end in the horizontal direction (hereinafter, referred to as the m-th column). In the example shown in FIG. 12, it is assumed that a=2, b=3, n=4, and m=5. The structure of the pixel Pᵤᵥ (1≦u, v≦n) is the same as that shown in FIG. 2. The pseudo signal generating circuits D₁₀ to Dₐ₀ are included in the divided-area-1, the pseudo signal generating circuits D₁ₘ to Dₐₘ are included in the divided-area-2, pseudo signal generating circuits D_{b0} to Dₙ₀ are included in the divided-area-3, and pseudo signal generating circuits D_{bm} to Dₙₘ are included in the divided-area-4.

According to the fourth embodiment, the pseudo signal generating circuits D₁₀ to Dₙ₀ and D₁ₘ to Dₙₘ are controlled by the level control circuit 41 and generate the pseudo signals at the desired levels. The structure of the pseudo signal generating circuits D₁₀ to Dₙ₀ and D₁ₘ to Dₙₘ is the same as that shown in FIG. 7.

The vertical scanning circuit 2 and vertical scanning circuit 3 select the corresponding rows and thus the pseudo signal generating circuits D₁₀ to Dₙ₀ output the pseudo signal generated to the 0-th vertical signal line. The pseudo signal reading circuits 51 and 53 at the divided-area-1 and divided-area-3 respectively fetch the pseudo signals outputted to the vertical signal lines at the 0-th columns in the divided-area-1 and divided-area-3, and output the fetched signals as the output-1 and output-3. The vertical scanning circuit 2 and vertical scanning circuit 3 select the corresponding rows and thus the pseudo signal generating circuits D₁ₘ to Dₙₘ output the pseudo signals generated at the vertical signal line at the m-th column. The pseudo signal reading circuits 52 and 54 in the divided-area-2 and divided-area-4 fetch the pseudo signals outputted to the vertical signal line at the respective m-th columns in the divided-area-2 and divided-area-4, and output the fetched signals as the output-2 and output-4.

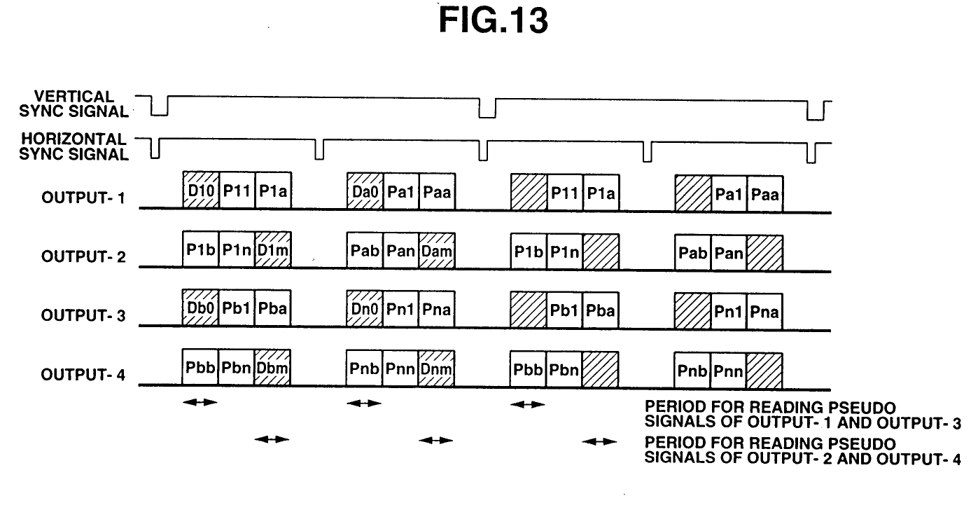

Next, the operation with the above-mentioned structure will be described with reference to FIGS. 13 to 15. FIGS. 13 to 15 are timing charts for explaining the signal reading by the output systems.

According to the fourth embodiment, the operations of the vertical scanning circuit 2 and vertical scanning circuit 3 and the horizontal reading circuits 11 to 14 are the same as those shown in FIG. 2.

The pseudo signal generating circuits D₁₀ to Dₙ₀ and D₁ₘ to Dₙₘ generate the pseudo signals at the desired levels under the control of the level control circuit 41. Vertical start pulses (not shown) are supplied to the vertical scanning circuit 2 and vertical scanning circuit 3, thereby starting the vertical scanning. Then, the vertical scanning circuit 2 and vertical scanning circuit 3 first output the row selecting signal to the horizontal selecting line at the first and third rows (first rows in the divided-area-1 to divided-area-4). Thus, in the case of the divided-area-1 and divided-area-2, the pseudo signals generated by the pseudo signal generating circuits D₁₀ and D₁ₘ at the first row thereof are outputted to the vertical signal lines at the 0-th column and the m-th column, and the pixel signals from the pixels P₁₁, P₁ₐ, P_{1b}, and P₁ₙ are outputted to the vertical signal lines at the first to n-th columns. Similarly, in the case of the divided-area-3 and divided-area-4, the pseudo signals generated by the pseudo signal generating circuits D_{b0} and D_{bm} at the first row thereof are outputted to the vertical signal lines at the 0-th column and the m-th column, and the pixel signals from the pixels P_{b1}, P_{ba}, P_{bb}, and P_{bn} are outputted to the vertical signal lines at the first to n-th columns.

In this state, in the case of the divided-area-1, the pseudo signal reading circuit 51 reads the output from the vertical signal line at the 0-th column (pseudo signal D₁₀), and outputs the read data as the output-1. In the case of the divided-area-2, the horizontal reading circuit 12 reads the output from the vertical signal line at the b-th column (pixel signal P_{1b}) and outputs the read data as the output-2. In the case of the divided-area-3, the pseudo signal reading circuit 53 reads the output from the vertical signal line at the 0-th column (pseudo signal D_{b0}) and outputs the read data as the output-3. In the case of the divided-area-4, the horizontal reading circuit 14 reads the output from the vertical signal line at the b-th column (pixel signal P_{bb}) and outputs the read data as the output-4 (refer to FIG. 13).

Subsequently, in the case of the divided-area-1, the horizontal reading circuit 11 selects the first column. In the case of the divided-area-2, the horizontal reading circuit 12 selects the n-th column. In the case of the divided-area-3, the horizontal reading circuit 13 selects the first column. In the case of the divided-area-4, the horizontal reading circuit 14 selects the n-th column.

Further, in the case of the divided-area-1, the horizontal reading circuit 11 selects the a-th column. In the case of the divided-area-2, the pseudo signal reading circuit 52 selects the m-th column. In the case of the divided-area-3, the horizontal reading circuit 13 selects the a-th column. In the case of the divided-area-4, the pseudo signal reading circuit 54 selects the m-th column.

As mentioned the reading operation shown in FIG. 13 is performed. The output-1 to output-4 can be made into the pseudo signals at the desired levels. Therefore, the pseudo signal can function as the test signal. The pseudo signal is monitored, thereby correcting the variation in properties of the reading circuits in the post-stage processing circuit.

According to the fourth embodiment, the pseudo signal generating circuit is arranged in the pixel area and thus there is a merit the symmetry is improved on the device layout and the area can be reduced.

According to the fourth embodiment, the pseudo signal output periods of the output-1 to output-4 are different from each other. However, the horizontal scanning directions in the divided-area-1 and divided-area-2 are opposite to the horizontal scanning directions in the divided-area-3 and divided-area-4. Consequently, the pseudo signal output periods of the output-1 to output-4 can be set to the same period in the horizontal scanning period.

According to the fourth embodiment, the pseudo signal generating circuits are arranged near the pixel area. However, they can be arranged in the inner of the pixel area. The influence on the image from the pseudo signal generating circuit arranged in the pixel area can be suppressed by the post-stage signal processing.

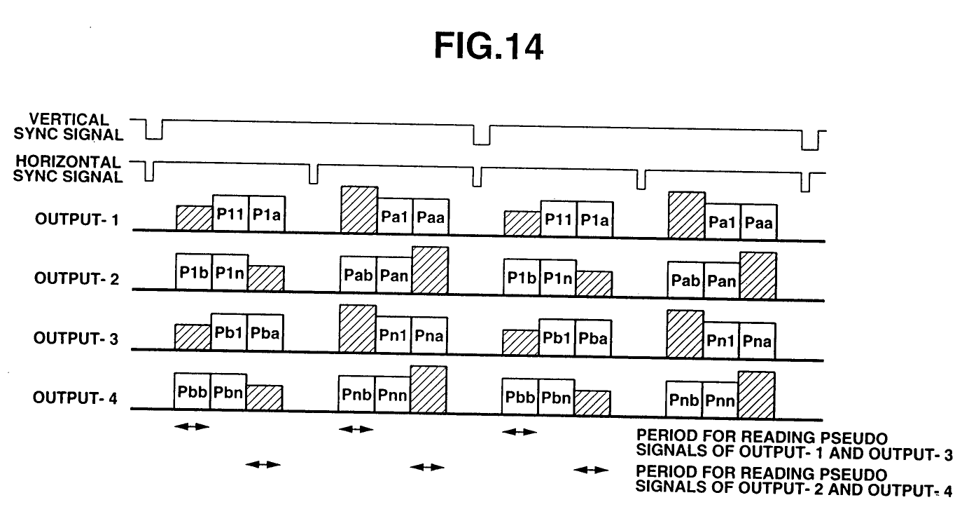

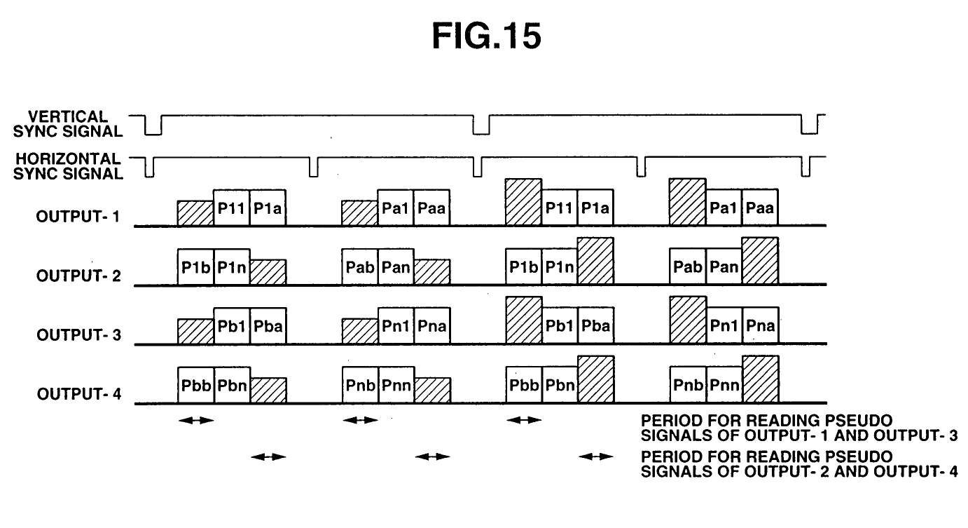

According to the fourth embodiment, the level control circuit 41 can change the levels of the pseudo signals outputted as the output-1 to output-4. FIGS. 14 and 15 show the examples in this case.

FIG. 14 shows an example in which the levels of the pseudo signals outputted as the output-1 to output-4 are changed every horizontal reading period in the vertical scanning period.

FIG. 15 shows an example in which the levels of the pseudo signals outputted as the output-1 to output-4 are mutually the same for the horizontal reading periods in the respective vertical scanning period and in which the levels of the pseudo signals change every vertical scanning period. As mentioned above, the pseudo signals at the desired levels can be obtained from the output systems.

According to the fourth embodiment, the level of the pseudo signal is controlled every horizontal cycle or frame cycle, thereby changing the level of the pseudo signal every horizontal cycle or frame cycle.

Obviously, the pseudo signal generating circuits may be arranged both in the horizontal direction and vertical direction by combining the third and fourth embodiments.

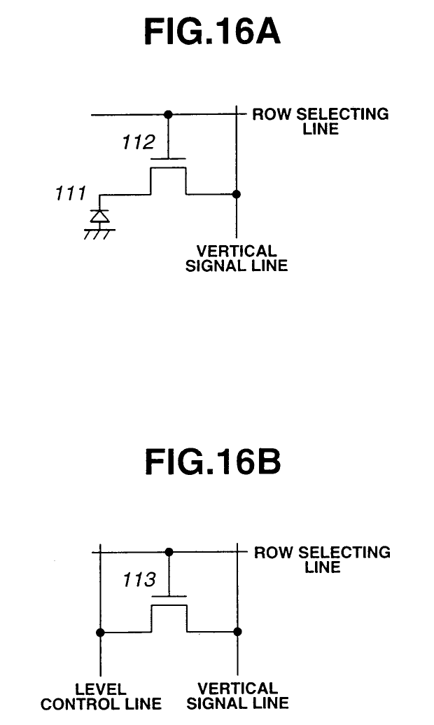

FIG. 16A and 16B are explanatory diagrams showing an image pick-up device according to the fifth embodiment of the present invention. FIG. 16A shows the circuit structure of pixels, and FIG. 16B shows the circuit structure of a pseudo signal generating circuit.

The fifth embodiment shows examples of the pseudo signal generating circuit implemented in FIG. 7, 10, or 12.

FIGS. 16A and 16B show examples of the structure of the pseudo signal generating circuit and the structure of the pixel in the pixel area which is one of a passive current reading system. Referring to FIG. 16A, a photodiode 111 is a photoelectrically converting element for generating a signal in accordance with the incident light amount. A signal from the photodiode 111 is outputted to the vertical signal line via a MOS transistor 112 which is on/off controlled by a row selecting signal supplied via a horizontal selecting line (hereinafter, referred to as a row selecting line) from the vertical scanning circuit.

The pseudo signal generating circuit shown in FIG. 16B has a MOS transistor 113 having the same structure as that of the MOS transistor 112 shown in FIG. 16A. The signal level of a level control line is controlled by a level control circuit. A source and a drain of the MOS transistor 113 are connected to the level control line and the vertical signal line. By turning on the MOS transistor 113 by the row selecting signal, the signal supplied to the level control line is outputted to the vertical signal line via the MOS transistor 113. The pseudo signal reading circuit or horizontal reading circuit reads the output from an output from the vertical signal line as the pseudo signal.

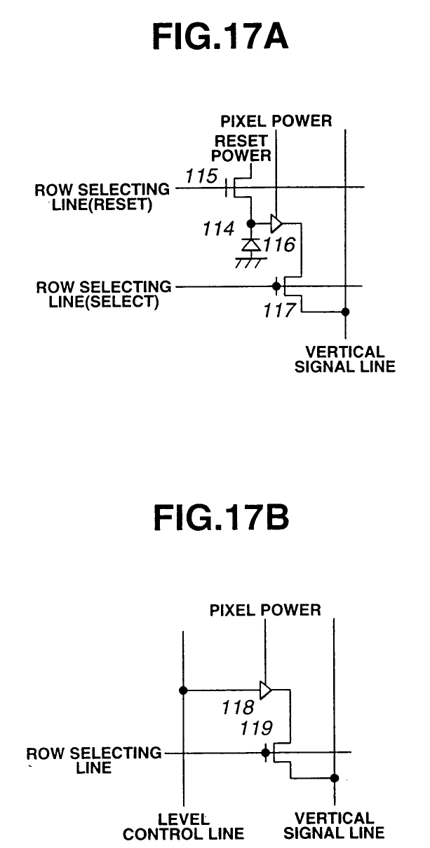

FIGS. 17A and 17B are explanatory diagrams showing an image pick-up device according to the sixth embodiment of the present invention, and another example of the pseudo signal generating circuit. FIG. 17A shows the circuit structure of the pixel and FIG. 17B shows the circuit structure of the pseudo signal generating circuit.

In the sixth embodiment, a case in which the pixel is one of a voltage reading system of an amplifying type (three-transistor type) is shown as an example of the pseudo signal generating circuit in FIG. 7, 10, or 12.

Referring to FIG. 17A, a photodiode 114 is a photoelectrically converting element for generating a signal in accordance with the incident light amount. A signal from the photodiode 114 is amplified by an in-pixel amplifier 116. An output terminal of the amplifier 116 is connected to the vertical signal via a MOS transistor 117 which is on/off controlled by the row selecting signal supplied via the row selecting line. By turning on the MOS transistor 117 by the row selecting signal, the signals stored in the photodiode 114 are amplified by the amplifier 116 and then are outputted to the vertical signal line.

The photodiode 114 is connected to a reset power supply via a MOS transistor 115 and receives a reset signal via the row selecting line. Thereby, the MOS transistor 115 is turned on, thus to reset the signals stored in the photodiode 114.

The pseudo signal generating circuit shown in FIG. 17B comprises: a MOS transistor 119 with the same structure as that of the MOS transistor 117 shown in FIG. 17A; and an in-pixel amplifier 118 with the same structure as that of the in-pixel amplifier 116. The signal level of the level control line is controlled by a level control circuit. By turning on the MOS transistor 119 by the row selecting signal, the signal supplied to the level control line is amplified by the amplifier 118. Then, the amplified signal is outputted to the vertical signal line via the MOS transistor 119. An output from the vertical signal line is read as the pseudo signal by the pseudo signal reading circuit or horizontal reading circuit.

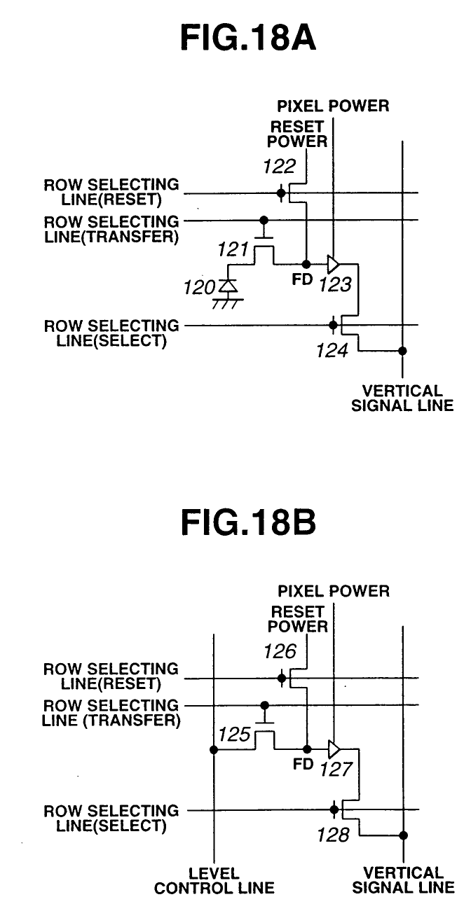

FIGS. 18A and 18B are explanatory diagrams showing an image pick-up device according to the seventh embodiment of the present invention, and showing another example of the pseudo signal generating circuit. FIG. 18A shows the circuit structure of pixels and FIG. 18B shows the circuit structure of the pseudo signal generating circuit.

In the seventh embodiment, a case in which the pixel is one of an amplifying type (four-transistor type) is shown as an example of the pseudo signal generating circuit shown in FIG. 7, 10, or 12.

Referring to FIG. 18A, a photodiode 120 is a photoelectrically converting element for generating a signal in accordance with the incident light amount. A MOS transistor 121 is on/off controlled by a row selecting signal outputted to the row selecting line from the vertical scanning circuit. A source and a drain of the MOS transistor 121 are connected between the photodiode 120 and a node FD. By turning on the MOS transistor 121, signal charges from the photodiode 120 are transferred to the node FD. At the node FD, the signal charges are converted into a voltage value. An in-pixel amplifier 123 amplifies a signal from the node FD, and outputs the amplified signal as a voltage signal. A MOS transistor 122 is on/off controlled by a signal outputted to the row selecting line from the vertical scanning circuit, thereby resetting the node FD.

A MOS transistor 124 is on/off controlled by the row selecting signal outputted to the row selecting line from the vertical scanning circuit. The row selecting signal turns on the MOS transistor 124, thereby selecting the pixel. Then, the signal amplified by the in-pixel amplifier 123 is outputted to the vertical signal line.

Referring to FIG. 18B, a MOS transistor 125 has the same structure as that of the MOS transistor 121, and is on/off controlled by the row selecting signal outputted to the row selecting line from the vertical scanning circuit. A MOS transistor 126 has the same structure as that of the MOS transistor 122, and is on/off controlled by the signal outputted to the row selecting line from the vertical scanning circuit. An in-pixel amplifier 127 has the same structure as that of the in-pixel amplifier 123, and amplifies the signal from the node FD.

A signal inputted from the level control line connected to the level control circuit is transferred to the node FD by the MOS transistor 125. Then, the transferred signal is amplified by the amplifier 127 and is outputted to the vertical signal line by turning on a selecting MOS transistor 128. An output from the vertical signal line is outputted by the pseudo signal reading circuit or horizontal reading circuit, thereby obtaining the pseudo signal.

The pixels and the pseudo signal generating circuit according to the fifth to seventh embodiments can properly be combined. There is a merit since the signal from the pseudo signal generating circuit is outputted in the same form as that of the pixel signal, the structure of the pseudo signal reading circuit is then is the same as that of the reading circuit of the pixel signal.

The pixels and the pseudo signal generating circuit according to the fifth to seventh embodiments are examples. The pixels and the pseudo signal generating circuit shown in FIGS. 7, 10, and 12 are not limited to those examples. It is possible to use any pixel and pseudo signal generating circuit as long as an image pick-up signal and a pseudo signal which can be used for the post-stage processing circuit can be obtained.

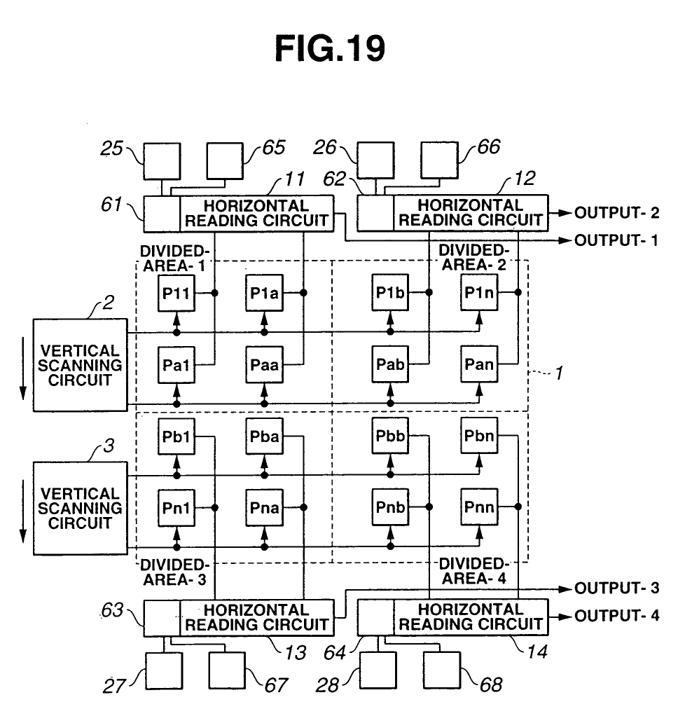

FIG. 19 is an explanatory diagram showing an image pick-up device according to the eighth embodiment of the present invention. Referring to FIG. 19, the same components as those shown in FIG. 2 are designated by the same reference numerals, and a description thereof is omitted.

According to the first to seventh embodiments, the pseudo signals at the different levels can be outputted in the pseudo signal generating circuit. On the contrary, the pseudo signal generating circuit according to the eighth embodiment generates the pseudo signal at the constant level, and changes the level of the pseudo signal outputted by the pseudo signal reading circuit.

Unlike the first embodiment, according to the eighth embodiment, in place of the pseudo signal reading circuits 21 to 24 shown in FIG. 2, pseudo signal reading circuits 61 to 64 are used and, in place of the level control circuits 29 to 32, level control circuits 65 to 68 are used.

Pseudo signal generating circuits 25 to 28 generate the pseudo signals at the constant level, and output the generated signals to the pseudo signal reading circuits 61 to 64. The pseudo signal reading circuits 61 to 64 have the same structures as those of the pseudo signal reading circuits 21 to 24 shown in FIG. 2, but can change reference-power-supply levels unlike the pseudo signal reading circuits 21 to 24. The level control circuits 65 to 68 control the reference-power-supply levels of the pseudo signal reading circuits 61 to 64.

With the above-mentioned structure according to the eighth embodiment, the level control circuits 65 to 68 control the reference-power-supply levels of the pseudo signal reading circuits 61 to 64. The pseudo signals at the constant level generated by the pseudo signal generating circuits 25 to 28 are converted into those at a desired level and are outputted upon reading the pseudo signal at the constant level by the pseudo signal reading circuits 61 to 64. Thus, the pseudo signals at the desired level are outputted as the output-1 to output-4 corresponding to the divided-area-1 to divided-area-4.

Another operation is the same as that according to the first embodiment.

As mentioned above, according to the eighth embodiment, when the pseudo signal reading circuits 61 to 64 read the pseudo signals at the constant level generated by the pseudo signal generating circuits 25 to 28, the level control circuits 65 to 68 control the reference-power-supply level in the pseudo signal reading circuits. Consequently, it is possible to change, to the desired level, the levels of the pseudo signals outputted as the output-1 to output-4. Therefore, the pseudo signal can function as a test signal. By monitoring the pseudo signal, the post-stage processing circuit can correct the variation in properties every reading circuit.

According to the eighth embodiment, the pseudo signal is outputted at the first timing of each horizontal reading period. However, the pseudo signal can be outputted at various timings similarly to the first embodiment.

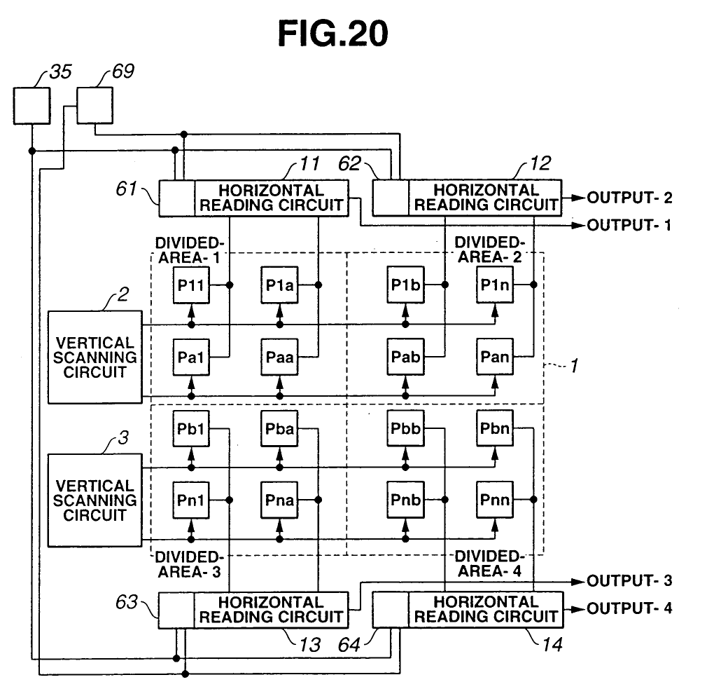

FIG. 20 is an explanatory diagram showing an image pick-up device according to the ninth embodiment of the present invention. Referring to FIG. 20, the same components as those shown in FIG. 6 are designated by the same reference numerals, and a description thereof is omitted.

According to the ninth embodiment, the pseudo signal generating circuit generates the pseudo signal at the constant level and the level of the pseudo signal outputted by the pseudo signal reading circuit is changed.

According to the ninth embodiment, in place of the respective pseudo signal reading circuits 21 to 24, the pseudo signal reading circuits 61 to 64 are used and, in place of the level control circuit 36, a level control circuit 69 is used unlike the case according to the second embodiment.

A pseudo signal generating circuit 35 generates the pseudo signal at the constant level, and outputs the generated signal to the pseudo signal reading circuits 61 to 64. The pseudo signal reading circuits 61 to 64 have the similar structure as that of the pseudo signal reading circuits 21 to 24 shown in FIG. 6, except for changing the reference-power-supply level. The level control circuit 69 controls the reference-power-supply levels of the pseudo signal reading circuits 61 to 64.

With the above-mentioned structure according to the ninth embodiment, the level control circuit 69 controls the reference-power-supply level of the pseudo signal reading circuits 61 to 64. When the pseudo signal reading circuits 61 to 64 read the pseudo signals at the constant level generated by the pseudo signal generating circuit 35, the pseudo signals at the constant level are converted into those at the desired level and are outputted. Thus, the pseudo signals at the desired levels are outputted as the output-1 to output-4 corresponding to the divided-area-1 to divided-area-4.

Another operation is the same as that according to the second embodiment.

As mentioned above, according to the ninth embodiment, when the pseudo signal reading circuits 61 to 64 read the pseudo signals at the constant level generated by the pseudo signal generating circuit 35, the level control circuit 69 controls the reference-power-supply level in the pseudo signal reading circuits. Consequently, the levels of the pseudo signals outputted as the output-1 to output-4 can be changed to the desired level. Therefore, the pseudo signal can function as the test signal. By monitoring the pseudo signal, it is possible to correct the variation in properties for every reading circuit in the post-stage processing circuit.

According to the ninth embodiment, the pseudo signal generating circuit 35 and the level control circuit 69 are respectively shared among the output systems. Thus, the correcting precision of the output system and the like using the pseudo signal is improved without bad influence from variation in pseudo signal generating circuit and level control circuit.

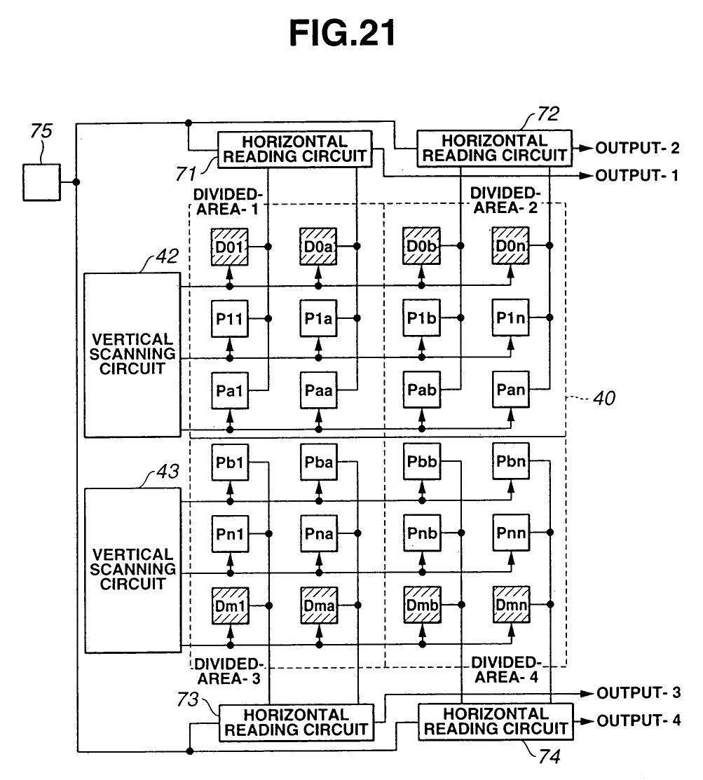

FIG. 21 is an explanatory diagram of an image pick-up device according to the tenth embodiment of the present invention. Referring to FIG. 21, the same components as those shown in FIG. 7 are designated by the same reference numerals, and a description thereof is omitted.

According to the tenth embodiment, the pseudo signal generating circuit generates the pseudo signal at the constant level and the level of the pseudo signal outputted by the pseudo signal reading circuit is changed.

According to the tenth embodiment, in place of the horizontal reading circuits 11 to 14 shown in FIG. 7, horizontal reading circuits 71 to 74 are used and, in place of the level control circuit 41, a level control circuit 75 is used unlike the case according to the third embodiment.

The pseudo signal generating circuits D₀₁ to D₀ₙ and Dₘ₁ to Dₘₙ generate the pseudo signals at the constant level. The horizontal reading circuits 71 to 74 have the similar structure as that of the horizontal reading circuits 11 to 14 shown in FIG. 7, except for the variation of the reference-power-supply level. The level control circuit 75 controls the reference-power-supply levels of the horizontal reading circuits 71 to 74.

With the above-mentioned structure according to the tenth embodiment, the level control circuit 75 controls the reference-power-supply levels of the horizontal reading circuits 71 to 74. When the horizontal reading circuits 71 to 74 read the pseudo signals at the constant level generated by the pseudo signal generating circuits D₀₁ to D₀ₙ and Dₘ₁ to Dₘₙ, they are converted into those at the desired level and are outputted. Thus, the pseudo signals at the desired levels are outputted as the output-1 to output-4 corresponding to the divided-area-1 to divided-area-4.

Another operation is the same as that according to the third embodiment.

As mentioned above, according to the tenth embodiment, when the horizontal reading circuits 71 to 74 read the pseudo signals at the constant level generated by the pseudo signal generating circuits D₀₁ to D₀ₙ and Dₘ₁ to Dₘₙ, the level control circuit 75 controls the reference-power-supply levels in the horizontal reading circuits 71 to 74. Consequently, the levels of the pseudo signals outputted as the output-1 to output-4 can be changed to the desired level. Therefore, the pseudo signal can function as the test signal. By monitoring the pseudo signal, it is possible to correct the variation in properties for every reading circuit in the post-stage processing circuit.

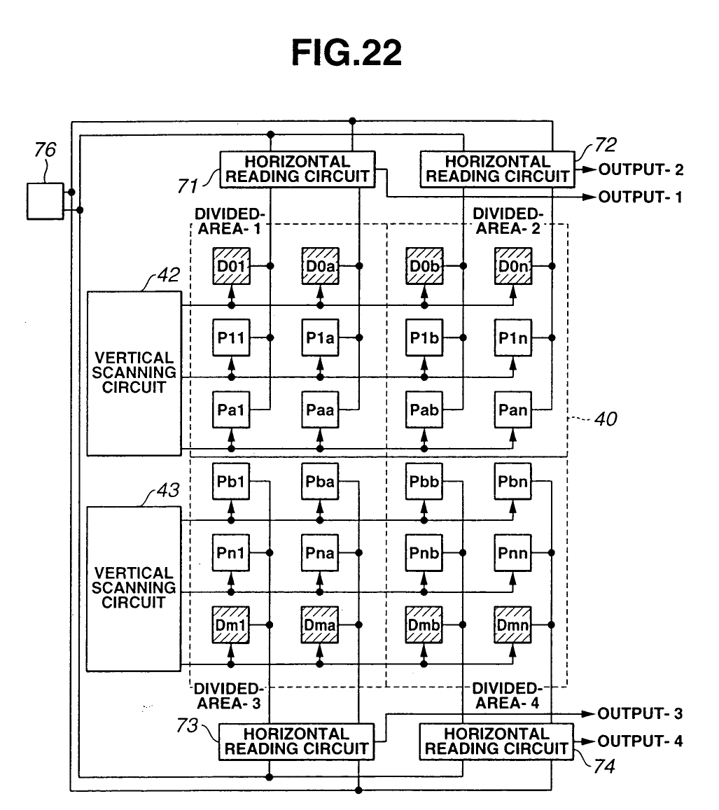

FIG. 22 is an explanatory diagram of an image pick-up device according to a modification of the tenth embodiment.

In the example shown in FIG. 22, in place of the level control circuit 75 shown in FIG. 21, a level control circuit 76 is used to control a plurality of types of levels, thus to individually control the levels of the pseudo signals from the pseudo signal generating circuit at the same row. One level control line from the level control circuit 76 supplies a signal for level control to the horizontal reading circuits 71 to 74, and another level control line from the level control circuit 76 supplies a signal for level control to the horizontal reading circuits 71 to 74.

When the horizontal reading circuits 71 to 74 read the signals from the pseudo signal generating circuits D₀₁, D_{0b}, Dₘ₁, and D_{mb} at the first columns in the respective divided-area-1 to divided-area-4, the horizontal reading circuits 71 to 74 output, for example, the pseudo signals at the levels based on the signals transferred by one level control line. When the horizontal reading circuits 71 to 74 read the signals from the pseudo signal generating circuits D₀ₐ, D₀ₙ, Dₘₐ, and Dₘₙ at the second columns in the respective divided-area-1 to divided-area-4, the horizontal reading circuits 71 to 74 output the pseudo signals at the levels based on the signals transferred by the other level control line. Thus, the level of the pseudo signal can be changed every pixel cycle. Obviously, the level can be controlled not only for every pseudo signal generating circuit, but also for every plural units of circuit.

As mentioned above, in this case, the pseudo signal at the desired level can be obtained from the output terminal. Therefore, the pseudo signal can function as the test signal. By monitoring the pseudo signal, it is possible to correct the variation in properties for every reading circuit in the post-stage processing circuit.

Another operation is the same as that according to the third embodiment.

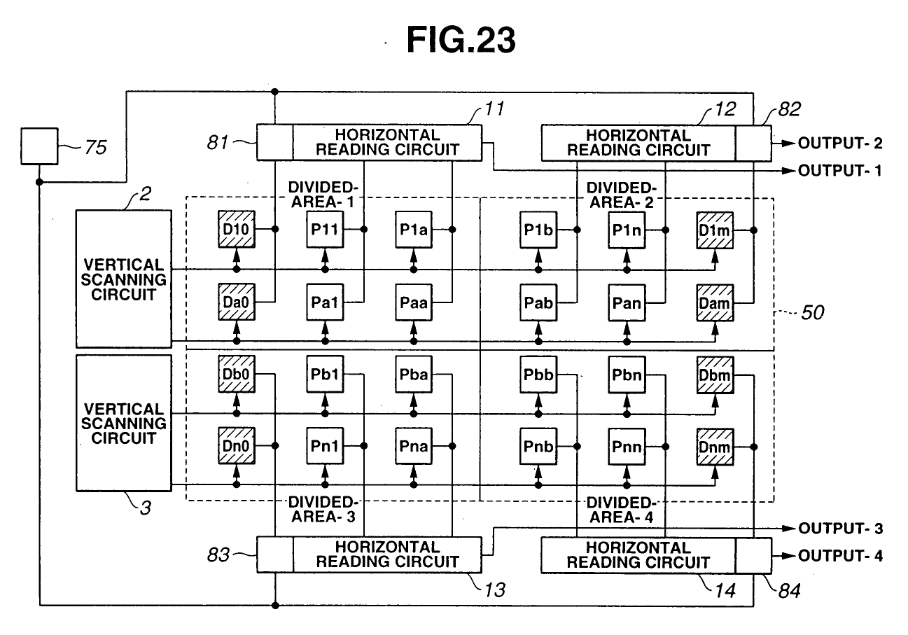

FIG. 23 is an explanatory diagram of an image pick-up device according to the eleventh embodiment of the present invention. Referring to FIG. 23, the same components as those shown in FIGS. 12 and 21 are designated by the same reference numerals, and a description thereof is omitted.

According to the eleventh embodiment, the pseudo signal generating circuit generates the pseudo signal at the constant level and the level of the pseudo signal outputted by the pseudo signal reading circuit is changed.

According to the eleventh embodiment, in place of the respective pseudo signal reading circuits 51 to 54 shown in FIG. 12, pseudo signal reading circuits 81 to 84 are used and, in place of the level control circuit 41, the level control circuit 75 is used unlike the case according to the fourth embodiment.

The pseudo signal generating circuits D₁₀ to D₀ₙ and D₁ₘ to Dₙₘ generate the pseudo signals at the constant level. The pseudo signal reading circuits 81 to 84 have the similar structure as those of the pseudo signal reading circuits 51 to 54 shown in FIG. 12, except for the variation of the reference-power-supply level. The level control circuit 75 controls the reference-power-supply levels of the pseudo signal reading circuits 81 to 84.

With the above-mentioned structure according to the eleventh embodiment, the level control circuit 75 controls the reference-power-supply levels of the pseudo signal reading circuits 81 to 84. When the pseudo signal reading circuits 81 to 84 read the pseudo signals at the constant level generated by the pseudo signal generating circuits D₁₀ to Dₙ₀ and D₁ₘ to Dₙₘ, the pseudo signals are converted into those at the desired level and-are outputted. Thus, the pseudo signals at the desired levels are outputted as the respective output-1 to output-4 corresponding to the divided-area-1 to divided-area-4.

Another operation is the same as that according to the fourth embodiment.

As mentioned above, according to the eleventh embodiment, when the pseudo signal reading circuits 81 to 84 read the pseudo signals at the constant level generated by the pseudo signal generating circuits D₁₀ to Dₙ₀ and D₁ₘ to Dₙₘ, the level control circuit 75 controls the reference-power-supply levels in the pseudo-signal reading circuits 81 to 84. Consequently, the levels of the pseudo signals outputted as the respective output-1 to output-4 can be changed to the desired level. Therefore, the pseudo signal can function as the test signal. By monitoring the pseudo signal, it is possible to correct the variation in properties for every reading circuit in the post-stage processing circuit.

Another advantage is the same as that according to the fourth embodiment.

By applying the tenth and eleventh embodiments, the pseudo signal generating circuits may be arranged both in the horizontal and vertical directions in the pixel area.

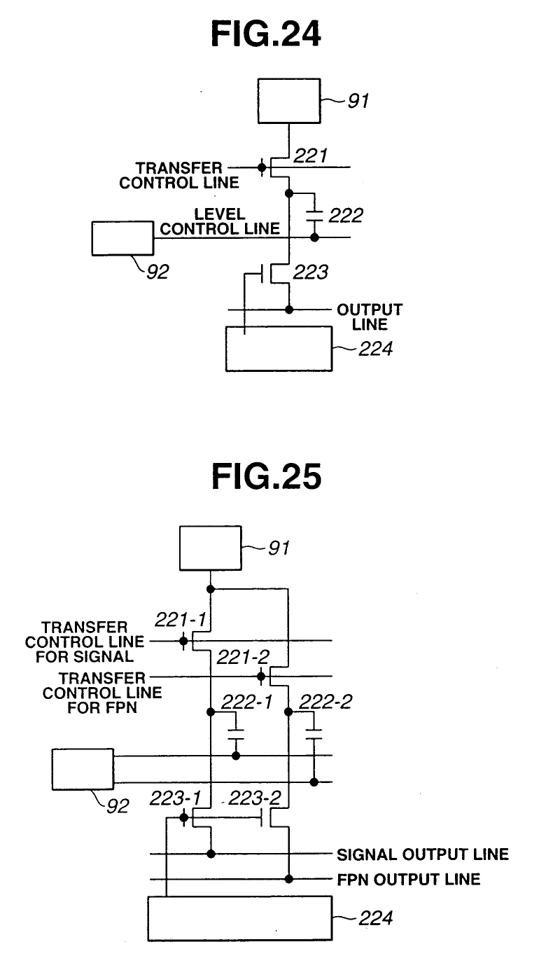

FIG. 24 is a circuit diagram showing an image pick-up device according to the twelfth embodiment of the present invention. According to the twelfth embodiment, the examples of the pseudo signal reading circuit and horizontal circuit shown in FIGS. 19 to 23 are shown.

Referring to FIG. 24, a pseudo signal generating circuit 91 corresponds to the pseudo signal generating circuits 25 to 28, 35, D₀₁ to D₀ₙ, and Dₘ₁ to Dₘₙ shown in FIGS. 19 to 23. A level control circuit 92 corresponds to the level control circuits 65 to 68, 69, 75, and 76 shown in FIGS. 19 to 23.

A memory element 222 stores the pseudo signal from the pseudo signal generating circuit 91, and the reference power thereof is supplied from the level control circuit 92. A MOS transistor 221 transfers the pseudo signal from the pseudo signal generating circuit 91, and is on/off controlled by a control signal supplied to a transfer control line omitted in FIGS. 19 to 23. A switch 223 selects the signal stored in the memory element 222, and outputs the selected signal to an output line. A selecting unit 224 comprises a shift register and controls on/off of the switch 223. The selecting unit 224 and the switch 223 have the same structure as that of the pulse transfer unit in the horizontal reading circuit shown in FIGS. 19 to 23.

In the pseudo signal reading circuit and horizontal reading circuit with the above-mentioned structure, the pseudo signal from the pseudo signal generating circuit 91 is supplied to the memory element 222 and is stored therein. Then, the level control circuit 92 controls the reference-power-supply level of the memory element 222. Thus, the pseudo signal stored in the memory element 222 is outputted from the memory element 222 at the level which is changed in accordance with the reference-power-supply level. The selecting unit 224 turns on the selecting switch 223, thereby outputting the pseudo signal from the memory element 222 to the output line.

For example, reference numeral V₁ denotes a signal level of the output terminal of the memory element 222 just after storing the pseudo signal, reference numeral V_{R1} denotes the level of the reference power in this case, and reference numeral V_{R2} denotes a level of the reference power line which is changed after storing. Then, a level V of the pseudo signal outputted to the outside is equal to [V₁+(V_{R2}−V_{R1})]. Thus, it is possible to change the signal level of the pseudo signal outputted by the change amount of the level of the reference power.

As mentioned above, according to the twelfth embodiment, the level control circuit 92 controls the level of the reference power, thereby obtaining the pseudo signal at the desired level.

FIG. 25 is a circuit diagram showing an image pick-up device according to the thirteenth embodiment of the present invention. According to the thirteenth embodiment, examples of the pseudo signal reading circuit and horizontal reading circuit shown in FIGS. 19 to 23 are shown. Referring to FIG. 25, the same components as those shown in FIG. 24 are designated by the same reference numerals and a description thereof is omitted.

As the pseudo signal generating circuit 91, a shielding pixel is used. However, in the case of the shielding pixel, noises, so-called FPN constituting variations among pixels might be mixed in. According to the thirteenth embodiment, the FPN can be canceled.

A memory element 222-1 stores the pseudo signal from the pseudo signal generating circuit 91 and the reference power of the memory element 222-1 is supplied from the level control circuit 92. According to the thirteenth embodiment, a memory element 222-2 is arranged to store the FPN from the pseudo signal generating circuit 91. The reference power of the memory element 222-2 is also supplied from the level control circuit 92. A MOS transistor 221-1 transfers the pseudo signal from the pseudo signal generating circuit 91, and is on/off controlled by a control signal supplied to a signal transfer control line which is omitted in FIGS. 19 to 23. A MOS transistor 221-2 transfers the FPN from the pseudo signal generating circuit 91 and is on/off controlled by a control signal supplied to a FPN transfer control line which is omitted in FIGS. 19 to 23.

A switch 223-1 selects the pseudo signal stored in the memory element 222-1 and outputs the selected pseudo signal to a signal output line. A switch 223-2 selects the FPN stored in the memory element 222-2 and outputs the selected FPN to an FPN output line. A selecting unit 224 comprises a shift register and controls on/off of the switches 223-1 and 223-2.

In the pseudo signal reading circuit or horizontal reading circuit with the above-mentioned structure, the pseudo signal from the pseudo signal generating circuit 91 is supplied and stored into the memory element 222-1. In the meantime, for example, in the case of using the shielding pixel as the pseudo signal generating circuit 91, a signal from the pixel in which charges based on the incident light are not stored is supplied and stored in the memory element 222-2 as the FPN. The difference between the signals stored in the memory element 222-1 and the signals stored in the memory element 222-2 is obtained, thereby removing the FPN included in the pseudo signal.

In the case of changing the level of the pseudo signal, the level control circuit 92 changes the levels of the reference power of the memory elements 222-1 and 222-2. Thus, the memory elements 222-1 and 222-2 output the signals stored respectively therein at the levels in accordance with the change in levels of the reference power. The selecting unit 224 turns on the selecting switches 223-1 and 223-2, thereby outputting the signals held in the memory elements 222-1 and 222-2 to the signal output line and the FPN output line respectively.

For example, reference numeral (V₁+V_{FPN}) denotes the signal level at the output terminal of the memory element 222-1 just after storing the pseudo signal, reference numeral (V_{R1}) denotes the level of the reference power in this case, reference numeral (V_{R2}) denotes the level of the reference power line changed after storage, reference numeral V_{FPN} denotes the signal level at the output terminal of the memory element 222-2 just after storing the FPN, reference numeral (V_{R1 FPN}) denotes the level of the reference power in this case, and reference numeral V_{R2 FPN} denotes the level of the level of the reference power line changed after storage. Then, a signal level Vₛ outputted to the signal output line is [Vₛ=V₁+V_{FPN}+(V_{R2}−V_{R1})]. A signal level Vₙ outputted to the FPN output line is [Vₙ=V_{FPN}+(V_{R2 FPN}−V_{R1 FPN})]. The difference of these outputs is obtained, resulting in the relation of [Vₛ−Vₙ=V₁+V_{FPN}+(V_{R2}−V_{R1})−V_{FPN}−(V_{R2 FPN}−V_{R1 FPN})=V₁+(V_{R2}−V_{R1})−(V_{R2 FPN}−V_{R1 FPN})]. That is, the FPN is canceled from the difference (Vₛ−Vₙ) of outputs, and the level of the pseudo signal becomes the value corresponding to the level change of the reference power.

As mentioned above, according to the thirteenth embodiment, the level control circuit 92 controls the level of the reference power, thereby obtaining the pseudo signal at the desired level. Further, the pseudo signal excluding the FPN is obtained.

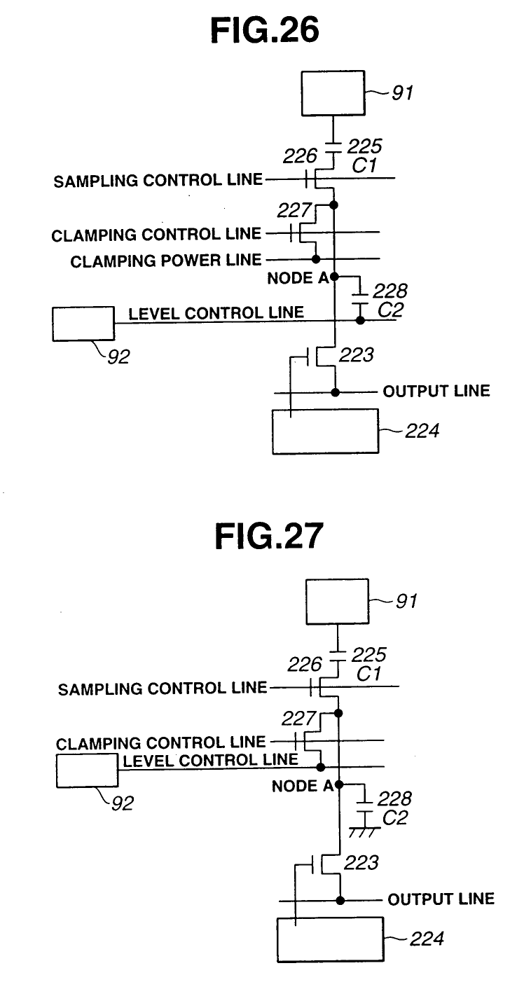

FIG. 26 shows examples of the pseudo signal reading circuit or horizontal reading circuit shown in FIGS. 19 to 23, and a circuit diagram showing another example of canceling the FPN. Referring to FIG. 26, the same components as those in FIG. 24 are designated by the reference numerals and a description thereof is omitted.

In the example shown in FIG. 26, the FPN is canceled by clamping the FPN.

Referring to FIG. 26, a clamping capacitor 225 is a capacitor to clamp the FPN from the pseudo signal generating circuit 91 and has a capacitance C₁. A sampling switch 226 and a clamping switch 227 are respectively on/off controlled by a signal transmitted via a sampling control line or a clamping control line. A holding capacitor 228 is a capacitor to hold the pseudo signal which is obtained by excluding the FPN from the pseudo signal generating circuit 91 and has a capacitance C₂. The reference power of the holding capacitor 228 is controlled by the level control circuit 92. The switches 223 and the selecting unit 224 select and output the signal stored in the holding capacitor 228 to the output line.

In the reading circuit with the above-described structure, the sampling switch 226 and the clamping switch 227 are first made conductive, the FPN of the pseudo signal generating circuit 91 is clamped to the clamping capacitor 225, and a node A, namely, the holding capacitor 228 is fixed to a clamping power supply. Here, reference numeral V_{c} denotes a clamping level. Next, the clamping switch 227 is made non-conductive and the pseudo signal from the pseudo signal generating circuit 91 is supplied to the clamping capacitor 225. Then, at the node A, the level changes by a value which is obtained by dividing the difference between the FPN and the pseudo signal by the clamping capacitor 225 and the holding capacitor 228.

That is, ΔV denotes the difference between the pseudo signal and the FPN of the pseudo signal generating circuit 91 based on the FPN level as the reference. Then, the level of the node A changes by [ΔV×C₁/(C₁+C₂)], thereby obtaining [V_{c}+ΔV×C₁/(C₁+C₂)]. Therefore, the holding capacitor 228 stores the pseudo signal from which the FPN is canceled. The pseudo signal held to the holding capacitor 228 is outputted to the output line via the selecting switch 223.

Herein, after storing the pseudo signal from which the FPN is canceled in the holding capacitor 228, the level control circuit 92 changes the level of the reference power of the holding capacitor 228, thereby changing the level of the pseudo signal outputted by the level change amount.

As mentioned above, in the example shown in FIG. 26, the level of the reference power line is controlled, thereby obtaining the pseudo signal at the desired level.

Incidentally, in the description referring to FIG. 26, the sequence is described to read the pseudo signal after clamping the FPN. However, the opposite sequence is possible. Further, the sampling switch shown in FIG. 26 may be arranged to the input side of the clamping capacitor.

FIG. 27 shows an example of the pseudo signal reading circuit or horizontal reading circuit shown in FIGS. 19 to 23, and a circuit diagram showing another example of clamping and canceling the FPN. Referring to FIG. 27, the same reference numerals as those shown in FIG. 26 are designated by the same reference numerals and a description thereof is omitted.

A reading circuit shown in FIG. 27 is different from the example shown in FIG. 26 in the point that the level control circuit 92 does not change the power level of the holding capacitor 228 but changes clamping power.

In the reading circuit with the above-described structure, the sampling switch 226 and the clamping switch 227 are made conductive, the FPN of the pseudo signal generating circuit 91 is clamped to the clamping capacitor 225, and the node A, namely, the holding capacitor 228 is fixed to the clamping power. Here, reference numeral V_{c} denotes the clamping level. Next, the clamping switch 227 is made non-conductive and the pseudo signal from the pseudo signal generating circuit 91 is supplied to the clamping capacitor 225. Then, at the node A, the level changes by a value which is obtained by dividing the difference between the FPN and the pseudo signal by the clamping capacitor 225 and the holding capacitor 226.

That is, ΔV denotes the difference between the pseudo signal and the FPN of the pseudo signal generating circuit 91 based on the FPN level as the reference. Then, the level of the node A changes by [ΔV×C₁/(C₁+C₂)], thereby obtaining [V_{c}+ΔV×C₁/(C₁+C₂)]. Therefore, the holding capacitor 228 stores the pseudo signal from which the FPN is canceled. The pseudo signal held to the holding capacitor 228 is outputted to the output line via the selecting switch 223.

Herein, the clamping level V_{c} can be controlled at the desired level by the level control circuit 92. That is, the node A just before outputting the pseudo signal to the output line, that is, the signal level [V_{c}+ΔV×C₁/(C₁+C₂)] of the holding capacitor 228 can be changed. Thus, the level control circuit 92 can change the signal level of the holding capacitor 228, namely, the level of the outputted pseudo signal.

In the example shown in FIG. 27, the sequence for reading the FPN after clamping the pseudo signal may be used. Further, the sampling switch may be arranged to the input side of the clamping capacitor.

The reading circuits shown in FIG. 24 to 27 are examples and may use any circuit structure as long as the pseudo signal usable in the post-stage processing circuit can be obtained.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image pick-up device comprising:
pseudo signal generating means which generates a pseudo video signal;
pseudo signal reading means which reads and outputs the pseudo signal from the pseudo signal generating means; and
level control means which controls the level of a signal outputted by the pseudo signal generating means.

2. An image pick-up device comprising:
pseudo signal generating means which generates a pseudo video signal at the constant level;
pseudo signal reading means which reads and outputs the pseudo signal from the pseudo signal generating means; and
level control means which controls the level of a signal outputted by the pseudo-signal reading means.

3. The image pick-up device according to claim 2, wherein the pseudo signal generating means uses a shielding pixel.

4. The image pick-up device according to claim 2, wherein the level control means controls a reference-power-supply level of the pseudo signal reading means.

5. The image pick-up device according to claim 2, wherein the level control means controls a clamping level of the signal outputted by the pseudo signal reading means.

6. The image pick-up device according to claim 1, wherein the level control means controls the level at a predetermined cycle.

7. The image pick-up device according to claim 2, wherein the level control means controls the level at a predetermined cycle.

8. The image pick-up device according to claim 1, wherein the level control means controls the level in predetermined pixel units.

9. The image pick-up device according to claim 2, wherein the level control means controls the level in predetermined pixel units.
